(19) United States
(12) Patent Application Publication
(10) Pub. No.: US 2026/0352088 A1
(43) Pub. Date: Nov. 5, 2026

(54) DRIVE CIRCUIT FOR POWER SEMICONDUCTOR ELEMENT AND POWER CONVERSION DEVICE

(71) Applicant: Mitsubishi Electric Corporation, Tokyo (JP)

(72) Inventors: Yoshiko TAMADA, Chiyoda-ku, Tokyo (JP); Shotaro YAMAMOTO, Chiyoda-ku, Tokyo (JP)

(73) Assignee: Mitsubishi Electric Corporation, Tokyo (JP)

(21) Appl. No.: 19/120,795

(22) PCT Filed: Nov. 7, 2022
(86) PCT No.: PCT/JP2022/041334

§ 371 Date: Apr. 14, 2025

(51) Int. Cl. H02M 1/08; H02M 3/158

(52) U.S. Cl. CPC H02M 1/08; H02M 3/158

(57) ABSTRACT

A power semiconductor element has a first main electrode on a high potential side, a second main electrode on a low potential side, a gate serving as a control electrode, and a diode connected in anti-parallel between the first main electrode and the second main electrode. A drive circuit for the power semiconductor element includes: a control circuit to selectively apply an on-bias voltage and an off-bias voltage to the gate of the power semiconductor element in accordance with a control signal inputted from outside; a detection circuit to detect a gate charge amount of the power semiconductor element; and a determination circuit to determine whether or not the diode of the power semiconductor element performs a freewheeling operation based on the gate charge amount detected by the detection circuit.

### TECHNICAL FIELD

The present disclosure relates to a drive circuit for a power semiconductor element, and a power conversion device.

### BACKGROUND ART

A drive circuit for a power semiconductor element (hereinafter also simply referred to as a “semiconductor element”) such as a metal oxide semiconductor filed effect transistor (MOSFET) and an insulated gate bipolar transistor (IGBT) is configured to apply a gate bias to a gate to turn on (bring into conduction)/off (cut off) the semiconductor element, and thereby control a current flowing through the semiconductor element. Such a drive circuit is also referred to as a “gate drive circuit”.

The gate bias includes an on-bias for turning on the semiconductor element and an off-bias for turning off the semiconductor element. The on-bias is a voltage more than or equal to a gate threshold voltage of the semiconductor element, and the off-bias is a voltage less than the gate threshold voltage. The gate threshold voltage of an ordinary IGBT or normally-off MOSFET is about 2 to 7 V. Therefore, in general, the on-bias is set to about 15 to 20 V, and the off-bias is set to −15 to 0 V.

In a power conversion device, a bridge circuit having two semiconductor elements connected in series is used. The drive circuit alternately turns on these two semiconductor elements in accordance with a control signal supplied from a control device. However, if ON periods overlap when one semiconductor element is turned off and the other semiconductor element is turned on, there may occur a short circuit phenomenon that the two semiconductor elements are simultaneously turned on and an excessive current flows. In order to prevent this short circuit phenomenon, a dead time in which both of the two semiconductor elements are turned off is set.

However, a long dead time may cause distortion in waveforms of a voltage and a current to be inputted to and outputted from the power conversion device, and may hinder high-frequency operation. Accordingly, there is a need to shorten the dead time as much as possible.

Further, it is known that an oxide film of the gate of the semiconductor element has a life with respect to application of the gate bias. In order to increase the life of the oxide film, it is necessary to relax an electric field to be applied to the oxide film, or to shorten a time of applying the gate bias.

As a technique for suppressing the progress of deterioration of a semiconductor element, for example, Japanese Patent Laying-Open No. 2019-68691 (PTL 1) discloses a drive circuit to drive an upper arm switch and a lower arm switch. In the drive circuit, among body diodes of the upper arm switch and the lower arm switch, a diode through which a freewheeling current flows in a dead time is defined as a target diode, a switch having the target diode is defined as a target switch, and the remaining switch is defined as a facing arm switch. The drive circuit is configured to maintain a gate bias of the target switch at a negative voltage over a period (hereinafter also referred to as a specified period) from timing after start timing of a dead time immediately after the target switch is switched to an OFF state, the timing being in the dead time, to a certain point in a period in which the facing arm switch is set to an ON state, and then to maintain the gate bias of the target switch at an OFF voltage until a subsequent dead time ends. It should be noted that the negative voltage is a voltage less than 0, and the OFF voltage is a voltage more than or equal to 0 and less than a gate threshold voltage.

### CITATION LIST

### Patent Literature

PTL 1: Japanese Patent Laying-Open No. 2019-68691

### SUMMARY OF INVENTION

### Technical Problem

The drive circuit described in PTL 1 maintains the gate bias of the target switch at the negative voltage over the specified period described above, and thereby prevents occurrence of self turning-on of the target switch when the facing arm switch is switched to the ON state.

However, in PTL 1, it is necessary to maintain the gate bias of the target switch at the negative voltage from the end of the dead time immediately after the target switch is switched to the OFF state to the end of turning-on of the facing arm switch. Accordingly, it is necessary to provide a time margin to a period from the end of the dead time t0 switching of the gate bias from the negative voltage to the OFF voltage. In this case, there is a concern that a time for which the negative voltage is applied to a gate of the target switch may be increased, which may affect the life of the oxide film. On the other hand, if the time margin is not provided to the period, it is not possible to maintain the gate bias of the target switch at the negative voltage to the end of the turning-on of the facing arm switch, and thus the self turning-on of the target switch may occur.

That is, in order to prevent the self turning-on of the target switch, it is necessary to apply the negative voltage without excess or deficiency with respect to a period required to turn on the facing arm switch. However, it has been difficult to accurately grasp such a period only from information inputted to the drive circuit for the target switch. In order to solve this difficulty, there is a method of separately preparing an insulated signal to sense timing at which the facing arm switch is turned on. However, this method has problems in terms of mounting area and cost.

Further, in PTL 1, in order to determine which of the upper arm switch and the lower arm switch is the target switch, each arm switch is provided with a sense terminal that outputs a minute current having a correlation with a current flowing between a first terminal and a second terminal, and a flow direction of the current is detected based on the minute current outputted from the sense terminal. In this technique, it is necessary to provide the sense terminal to each semiconductor element, and thus there is a problem in terms of cost.

The present disclosure has been made to solve such problems, and a main object thereof is to provide a drive circuit that can determine a freewheeling operation of a diode of a power semiconductor element with a simple configuration.

### Solution to Problem

A drive circuit according to one aspect of the present disclosure is a drive circuit to drive a power semiconductor element. The power semiconductor element has a first main electrode on a high potential side, a second main electrode on a low potential side, a gate serving as a control electrode, and a diode connected in anti-parallel between the first main electrode and the second main electrode. The drive circuit includes: a control circuit to selectively apply an on-bias voltage and an off-bias voltage to the gate of the power semiconductor element in accordance with a control signal inputted from outside; a detection circuit to detect a gate charge amount of the power semiconductor element; and a determination circuit to determine whether or not the diode of the power semiconductor element performs a freewheeling operation based on the gate charge amount detected by the detection circuit.

### Advantageous Effects of Invention

According to the present disclosure, it is possible to determine the freewheeling operation of the power semiconductor element with a simple configuration. Thus, it is possible to appropriately activate a circuit for suppressing self turning-on of the power semiconductor element exactly when the power semiconductor element performs the freewheeling operation.

### BRIEF DESCRIPTION OF DRAWINGS

FIG. 1 is a main circuit configuration diagram of a power conversion device according to a first embodiment.

FIG. 2 is a block diagram showing an exemplary configuration of a gate drive circuit according to a comparative example.

FIG. 3 is a diagram illustrating operations of semiconductor elements.

FIG. 4 is a diagram illustrating operations of the semiconductor elements.

FIG. 5 is a time chart showing the operations of the semiconductor elements shown in FIG. 4.

FIG. 6 is a diagram illustrating self turning-on of an N-side semiconductor element.

FIG. 7 is a block diagram showing an exemplary configuration of a gate drive circuit according to the first embodiment.

FIG. 8 is a time chart showing operations of semiconductor elements.

FIG. 9 is a flowchart showing an operation of the gate drive circuit according to the first embodiment.

FIG. 10 is a diagram showing an exemplary circuit configuration of the gate drive circuit according to the first embodiment.

FIG. 11 is a block diagram showing an exemplary configuration of a gate drive circuit according to a third embodiment.

FIG. 12 is a block diagram showing an exemplary configuration of a gate drive circuit according to a fourth embodiment.

FIG. 13 is a diagram showing an exemplary circuit configuration of the gate drive circuit according to the fourth embodiment.

FIG. 14 is a time chart showing operations of semiconductor elements.

FIG. 15 is a flowchart showing an operation of the gate drive circuit according to the fourth embodiment.

### DESCRIPTION OF EMBODIMENTS

Hereinafter, embodiments of the present disclosure will be described in detail with reference to the drawings. It should be noted that, in the following, the same or corresponding parts in the drawings will be designated by the same reference numerals, and the description thereof will not be repeated in principle.

### First Embodiment

### Exemplary Configuration of Power Conversion Device

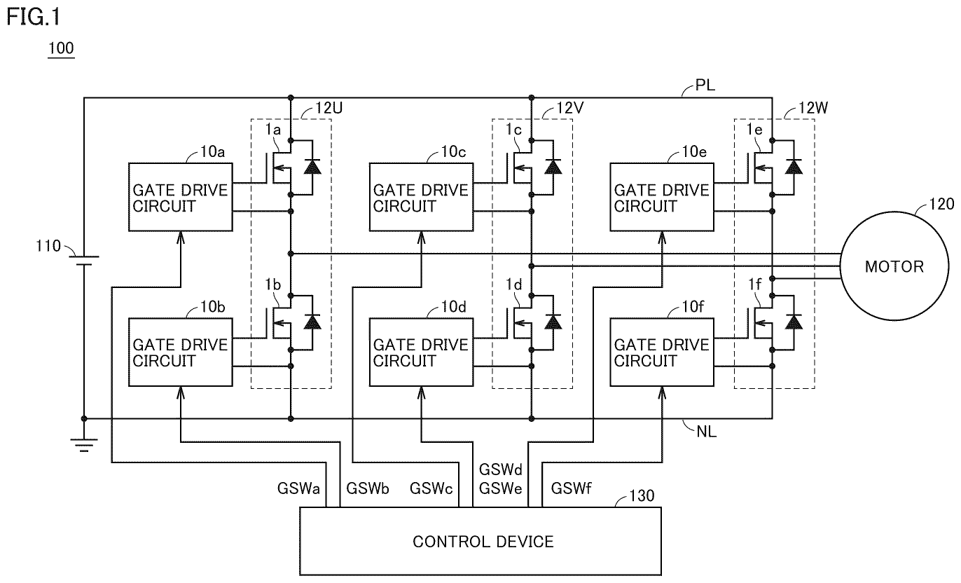

FIG. 1 is a main circuit configuration diagram of a power conversion device according to a first embodiment of the present disclosure. A power conversion device 100 according to the first embodiment is a three-phase (U, V, W) inverter that performs bidirectional power conversion between a direct current (DC) power supply 110 and a motor 120 serving as a load. Motor 120 is an induction motor or a synchronous motor, for example. Power conversion device 100 is not limited to an inverter, and may be a non-insulated synchronous rectification converter, for example.

As shown in FIG. 1, power conversion device 100 includes three legs 12U, 12V, and 12W, and six gate drive circuits 10a to 10f. Three legs 12U, 12V, and 12W are connected in parallel with each other between a DC positive bus PL and a DC negative bus NL. DC positive bus PL is electrically connected with a positive electrode terminal of DC power supply 110. DC negative bus NL is electrically connected with a negative electrode terminal of DC power supply 110. In the present specification, “electrically connected” means a connection state in which electric energy can be transmitted by direct connection or connection via another element.

Leg 12U has two power semiconductor elements (hereinafter also simply referred to as “semiconductor elements”) 1a and 1b connected in series. Leg 12V has two semiconductor elements 1c and 1d connected in series. Leg 12W has two semiconductor elements le and 1f connected in series. That is, each of legs 12U, 12V, and 12W is constituted by a bridge circuit. A connection node between semiconductor elements 1a and 1b, a connection node between semiconductor elements 1c and 1d, and a connection node between semiconductor elements le and 1f are connected to motor 120.

In the following, when semiconductor elements 1a to 1f are not particularly distinguished from each other, they may be collectively referred to as a “semiconductor element 1”. Further, in legs 12U, 12V, and 12W, semiconductor elements 1a, 1c, and 1d each having a main electrode on a high potential side connected to DC positive bus PL and a main electrode on a low potential side connected to motor 120 may be referred to as “P-side semiconductor elements”. Semiconductor elements 1b, 1d, and If each having a main electrode on the high potential side connected to motor 120 and a main electrode on the low potential side connected to DC negative bus NL may be referred to as “N-side semiconductor elements”.

Although a metal oxide semiconductor field effect transistor (MOSFET) is used as semiconductor element 1 in FIG. 1, any voltage-driven semiconductor element such as an insulated gate bipolar transistor (IGBT) can be used.

Semiconductor element 1 has a diode connected in anti-parallel. The diode is provided to allow a freewheeling current to flow when corresponding semiconductor element 1 is turned off. In a case where semiconductor element 1 is a MOSFET, a freewheel diode may be constituted by a parasitic diode (body diode). In a case where semiconductor element 1 is an IGBT not including a diode, the freewheel diode is constituted by a diode connected in anti-parallel to the IGBT.

A control device 130 generates gate command signals GSWa to GSWf which are control signals for controlling turning on/off of semiconductor elements 1a to 1f.

Specifically, control device 130 generates a gate command signal GSW at an H (logical high) level in a period in which semiconductor element 1 should be turned on (conductive), and generates gate command signal GSW at an L (logical low) level in a period in which semiconductor element 1 should be turned off (cut off). Gate command signal GSW at the H level corresponds to an “ON command”, and gate command signal GSW at the L level corresponds to an “OFF command”.

Gate drive circuits 10a to 10f are provided corresponding to semiconductor elements 1a to 1f, respectively. Gate drive circuits 10a to 10f drive corresponding semiconductor elements 1 in accordance with gate command signals GSWa to GSWf supplied from control device 130, and thereby control ON/OFF operations of semiconductor elements 1a to 1f. Specifically, each of gate drive circuits 10a to 10f is configured to apply an on-bias voltage to a control electrode (gate) of corresponding semiconductor element 1 in response to gate command signal GSW at the H level (an ON command), and to apply an off-bias voltage to a gate terminal of corresponding semiconductor element 1 in response to gate command signal GSW at the L level (an OFF command). In the following, when gate drive circuits 10a to 10f are not particularly distinguished from each other, they may be collectively referred to as a “gate drive circuit 10”.

Thereby, power conversion device 100 can perform an inverting operation of converting DC power supplied from DC power supply 110 into three-phase alternating current (AC) power and supplying the three-phase AC power to motor 120, and a rectifying operation of converting three-phase AC power supplied from motor 120 into DC power and supplying the DC power to DC power supply 110.

### Configuration of Gate Drive Circuit

Next, a configuration of gate drive circuit 10 according to the first embodiment will be described.

### Exemplary Configuration of Gate Drive Circuit According to Comparative Example

First, a configuration of an ordinary gate drive circuit will be described as a comparative example of the gate drive circuit according to the first embodiment.

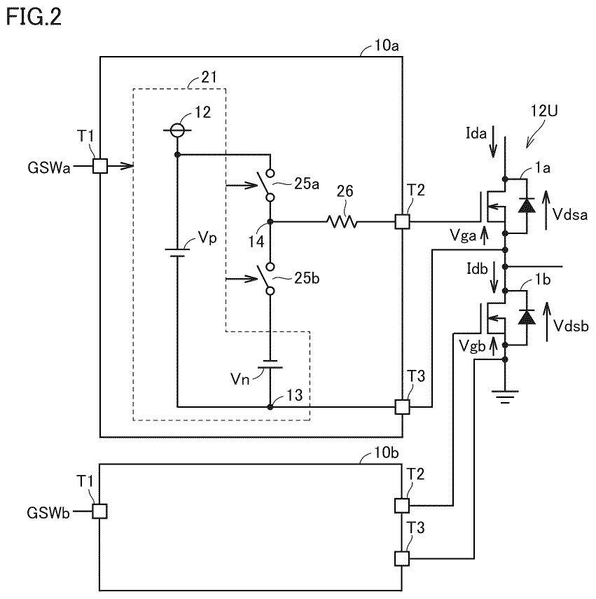

FIG. 2 is a block diagram showing an exemplary configuration of gate drive circuit 10a according to the comparative example. Gate drive circuit 10a drives P-side semiconductor element 1a. Since gate drive circuit 10a to drive P-side semiconductor element 1a and gate drive circuit 10b to drive N-side semiconductor element 1b basically have a common configuration, the configuration of gate drive circuit 10a will be representatively described below.

As shown in FIG. 2, gate drive circuit 10a is configured to include an input terminal T1, output terminals T2 and T3, a control circuit 21, switches 25a and 25b, and a gate resistor 26.

Input terminal T1 is connected to control device 130 (see FIG. 1). Input terminal T1 transfers gate command signal GSWa supplied from control device 130 to control circuit 21. Output terminal T2 is connected to the gate serving as the control electrode of semiconductor element 1a. Output terminal T3 is connected to a source serving as the main electrode on the low potential side of semiconductor element 1a, and to a reference node 13.

Control circuit 21 has an on-bias power supply Vp for generating an on-bias voltage Vp to be applied to the gate of semiconductor element 1a, and an off-bias power supply Vn for generating an off-bias voltage Vn to be applied to the gate of semiconductor element 1a. On-bias power supply Vp has a positive electrode terminal connected to a power supply node 12, and a negative electrode terminal connected to reference node 13. Off-bias power supply Vn has a positive electrode terminal connected to reference node 13, and a negative electrode terminal electrically connected to an output node 14.

Switch 25a is connected between power supply node 12 and output node 14. Switch 25b is connected between output node 14 and the negative electrode terminal of off-bias power supply Vn. Gate resistor 26 is connected between output node 14 and output terminal T2.

Control circuit 21 selectively turns on/off switches 25a and 25b in response to gate command signal GSWa. Specifically, when gate command signal GSWa is at the HI level, control circuit 21 turns on switch 25a and turns off switch 25b. Thereby, output node 14 is connected to power supply node 12, and thus on-bias power supply Vp is connected between output terminals T2 and T3. As a result, on-bias voltage Vp is applied between the gate and the source of semiconductor element 1a. On-bias voltage Vp is a voltage higher than a gate threshold voltage Vth of semiconductor element 1.

On the other hand, when gate command signal GSwa is at the L level, control circuit 21 turns off switch 25a and turns on switch 25b. Thereby, output node 14 is connected to the negative electrode terminal of off-bias power supply Vn, and thus off-bias power supply Vn is connected between output terminals T2 and T3. As a result, off-bias voltage Vn is applied between the gate and the source of semiconductor element 1a. Off-bias voltage Vn is a voltage less than gate threshold voltage Vth of semiconductor element 1.

In the following description, a voltage applied between the gate and the source of semiconductor element 1a (hereinafter referred to as a “gate voltage” thereof) will be designated by Vga, a voltage applied between a drain and the source of semiconductor element 1a (hereinafter referred to as a “drain voltage” thereof) will be designated by Vdsa, and a current flowing through the drain of semiconductor element 1a (hereinafter referred to as a “drain current” thereof) will be designated by Ida. A gate voltage of semiconductor element 1b will be designated by Vgb, a drain voltage of semiconductor element 1b will be designated by Vdsb, and a drain current of semiconductor element 1b will be designated by Idb.

### ON/OFF Operations of Semiconductor Elements 1a and 1b

Semiconductor elements 1a and 1b constituting leg 12U are complementarily turned on/off by gate drive circuits 10a and 10b. It should be noted that, while semiconductor elements 1a and 1b are turned on/off, a dead time Td, which is a period in which both semiconductor elements 1a and 1b are in an OFF state, is set such that an ON period of P-side semiconductor element 1a and an ON period of N-side semiconductor element 1b do not overlap with each other.

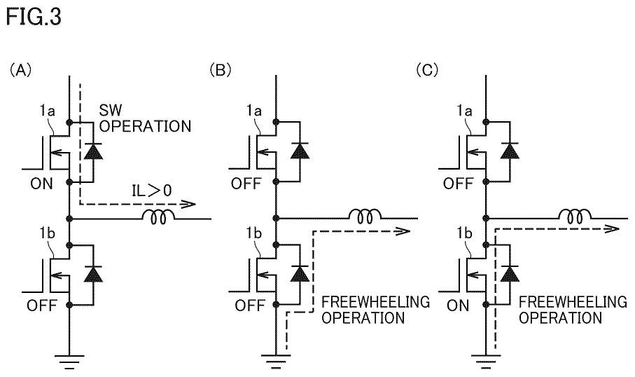

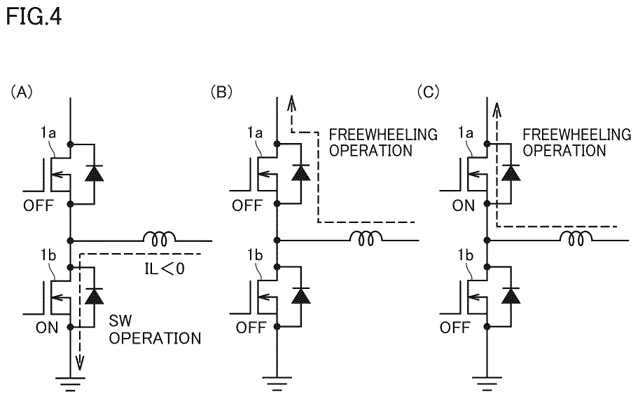

FIGS. 3 and 4 are diagrams illustrating operations of semiconductor elements 1a and 1b. In the following description, a phase current flowing through a winding of motor 120 is designated by IL, a direction in which phase current IL flows from the connection node between semiconductor elements 1a and 1b toward the winding is defined as a positive direction, and a direction in which phase current IL flows from the winding toward the connection node between semiconductor elements 1a and 1b is defined as a negative direction.

FIG. 3 shows ON/OFF operations of semiconductor elements 1a and 1b when a flow direction of phase current IL is the positive direction. In the ON period of semiconductor element 1a, as shown in FIG. 3 (A), semiconductor element 1b is set to the OFF state. Therefore, a current flows from the drain of semiconductor element 1a, via the source thereof, through the winding.

In dead time Td, as shown in FIG. 3 (B), semiconductor elements 1a and 1b are set to the OFF state. Since the winding acts to allow a current to flow continuously, a freewheeling current flows, via the diode of semiconductor element 1b, through the winding.

Then, in the ON period of semiconductor element 1b, as shown in FIG. 3 (C), semiconductor element 1a is set to the OFF state. Since semiconductor element 1b is turned on, the freewheeling current flows from a source of semiconductor element 1b, via a drain thereof, through the winding.

While the freewheeling current flows through the diode, a loss is caused by a forward voltage of the diode. Generally, this loss is greater than a loss caused by an on-resistance of the MOSFET. Accordingly, semiconductor element 1b is turned on during a freewheeling period excluding dead time Td, to allow the freewheeling current to flow through semiconductor element 1b (see FIG. 3 (C)).

FIG. 4 shows ON/OFF operations of semiconductor elements 1a and 1b when the flow direction of phase current IL is the negative direction. In the ON period of semiconductor element 1b, as shown in FIG. 4 (A), semiconductor element 1a is set to the OFF state. Therefore, a current flows from the winding, via the drain of semiconductor element 1a, through the source thereof.

In dead time Td, as shown in FIG. 4 (B), semiconductor elements 1a and 1b are set to the OFF state. Since the winding acts to allow a current to flow continuously, a freewheeling current flows, via the diode of semiconductor element 1a, through the winding.

Then, in the ON period of semiconductor element 1a, as shown in FIG. 4 (C), semiconductor element 1a is set to the OFF state. Since semiconductor element 1a is turned on, the freewheeling current flows from the winding, via the source of semiconductor element 1a, to the drain thereof. As described above, in order to reduce the loss, semiconductor element 1a is turned on during a freewheeling period excluding dead time Td, to allow the freewheeling current to flow through semiconductor element 1a.

In the present specification, an operation in which a current flows in a forward direction from the drain to the source of semiconductor element 1 is defined as a “SW (switching) operation”. On the other hand, an operation in which a current (freewheeling current) flows through the diode of semiconductor element 1 or from the source of semiconductor element 1 to the drain thereof is defined as a “freewheeling operation”.

When phase current IL flows in the positive direction as shown in FIG. 3, P-side semiconductor element 1a performs the SW operation and N-side semiconductor element 1b performs the freewheeling operation. When phase current IL flows in the negative direction as shown in FIG. 4, N-side semiconductor element 1b performs the SW operation and P-side semiconductor element 1a performs the freewheeling operation.

### Operation of Gate Drive Circuit According to Comparative Example

Next, an operation of the gate drive circuit according to the comparative example will be described.

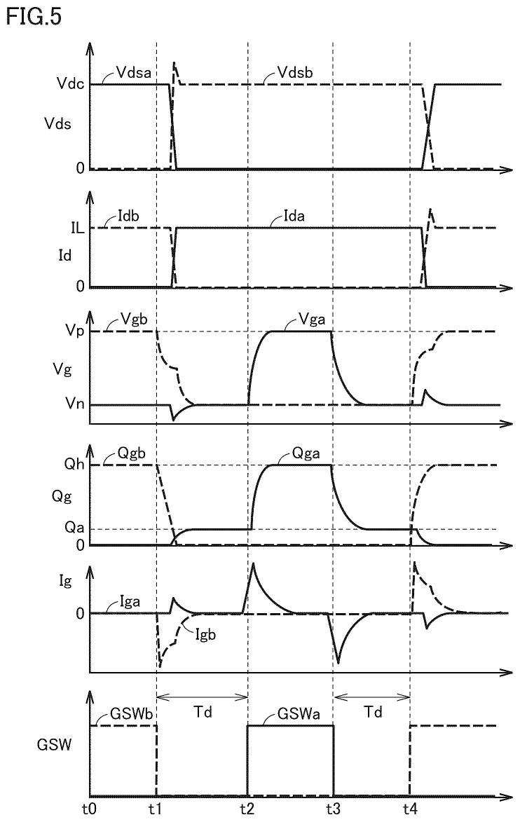

FIG. 5 is a time chart showing the operations of semiconductor elements 1a and 1b shown in FIG. 4. FIG. 5 shows waveforms of a drain voltage Vds, a drain current Id, a gate voltage Vg, a gate charge amount Qg, a gate current Ig, and gate command signal GSW of semiconductor elements 1a and 1b. In each waveform, a solid line indicates a waveform of P-side semiconductor element 1a, and a broken line indicates a waveform of N-side semiconductor element 1b.

It should be noted that gate charge amount Qg is a charge amount stored in Cgd (a gate-source capacitance) and Cgs (a gate-source capacitance) which are parasitic capacitances of the gate of semiconductor element 1. Gate charge amount Qg can be obtained by time-integrating gate current Ig. A direction in which gate current Ig charges gate parasitic capacitances Cgd and Cgs is defined as a positive direction, and a direction in which gate current Ig discharges gate parasitic capacitances Cgd and Cgs is defined as a negative direction. In the following description, gate charge amount Qg of semiconductor element 1a will be designated by Qga, and gate charge amount Qg of semiconductor element 1b will be designated by Qgb.

As shown in FIG. 5, at a time t0, gate command signal GSWa is at the L level, and gate command signal GSWb is at the H level. Gate drive circuit 10a turns on switch 15b and turns off switch 15a in response to gate command signal GSWa at the L level, and thereby applies off-bias voltage Vn to the gate of semiconductor element 1a. Therefore, gate voltage Vga of semiconductor element 1a is set to off-bias voltage Vn, and semiconductor element 1a is set to the OFF state. Accordingly, drain current Ida is set as Ida=0, and drain voltage Vdsa is set as Vdsa=VDC. VDC corresponds to an inter-terminal voltage of DC power supply 110. Since gate parasitic capacitances Cgd and Cgs of semiconductor element 1a are discharged, gate charge amount Qga is set to 0.

On the other hand, gate drive circuit 10b turns on switch 15a and turns off switch 15b in response to gate command signal GSWb at the H level, and thereby applies on-bias voltage Vp to the gate of N-side semiconductor element 1b. Therefore, gate voltage Vgb of semiconductor element 1b is set to on-bias voltage Vp, and semiconductor element 1b is set to an ON state.

As shown in FIG. 4 (A), a forward current flows between the drain and the source of semiconductor element 1b, and semiconductor element 1b performs the SW operation. Drain current Idb has a magnitude equal to that of phase current IL, and drain voltage Vdsa is set as Vdsa=0. Since gate parasitic capacitances Cgs and Cgd of semiconductor element 1b are charged by a gate current Igb, gate charge amount Qgb is set to Qh.

When gate command signal GSWb transitions from the H level to the L level at a time t1, semiconductor element 1b is turned off. Specifically, gate drive circuit 10b turns off switch 15a and turns on switch 15b in response to gate command signal GSWb at the L level, and thereby switches a voltage to be applied to the gate of semiconductor element 1b from on-bias voltage Vp to off-bias voltage Vn.

Thereby, the charge stored in gate parasitic capacitances Cgs and Cgd of semiconductor element 1b is discharged via gate resistor 26 and switch 25b, and thus gate charge amount Qgb gradually decreases from Qh. Accordingly, gate voltage Vgb gradually decreases from on-bias voltage Vp toward off-bias voltage Vn.

When gate voltage Vgb becomes less than gate threshold voltage Vth, semiconductor element 1b starts to be turned off. When semiconductor element 1b is turned off, drain current Idb starts to decrease, and drain voltage Vdsb starts to increase. Gate current Igb (a discharge current) flows from time t1 to when discharging of gate parasitic capacitances Cgs and Cgd is completed and gate charge amount Qgb is set to 0.

In response to turning-off of semiconductor element 1b, as shown in FIG. 4 (B), a freewheeling current flows through the diode of semiconductor element 1a. In response to the freewheeling current starting to flow through the diode, drain voltage Vdsa of semiconductor element 1a starts to decrease, and drain current Ida thereof starts to increase. When a change in voltage with respect to time in a transient period in which drain voltage Vdsa steeply changes is designated by dv/dt, while dv/dt occurs, a displacement current (Cgd×dv/dt) flows through gate-drain capacitance Cgd of semiconductor element 1a. Since this displacement current flows through gate resistor 26, gate voltage Vga decreases. Further, since gate parasitic capacitances Cgd and Cgs are charged by the displacement current, gate charge amount Qga increases from 0 to Qa. Qa is greater than 0 and smaller than Qh.

A period from time t1 to a time t2 corresponds to dead time Td. In dead time Td, the freewheeling current continues to flow through the diode of semiconductor element 1a.

When gate command signal GSWa transitions from the L level to the H level at time t2, semiconductor element 1a is turned on. Specifically, gate drive circuit 10a turns on switch 15a and turns off switch 15b in response to gate command signal GSWa at the H level, and thereby switches a voltage to be applied to the gate of semiconductor element 1a from off-bias voltage Vn to off-bias voltage Vp.

Thereby, a gate current Iga flows from power supply node 12 to the gate of semiconductor element 1a via gate resistor 26, and gate parasitic capacitances Cgs and Cgd are charged. Gate charge amount Qga gradually increases from Qa and reaches Qh. When charging is completed, gate current Iga stops flowing. Thereafter, on-bias voltage Vp is continuously applied to the gate of semiconductor element 1a, and thus semiconductor element 1a is maintained in the ON state. As shown in FIG. 4 (C), the freewheeling current flows between the drain and the source of semiconductor element 1a, and semiconductor element 1a performs the freewheeling operation.

When gate command signal GSWa transitions from the H level to the L level at a time t3, semiconductor element 1a is turned off. Specifically, gate drive circuit 10a turns off switch 15a and turns on switch 15b in response to gate command signal GSWa at the L level, and thereby switches the voltage to be applied to the gate of semiconductor element 1a from on-bias voltage Vp to off-bias voltage Vn.

Thereby, the charge stored in gate parasitic capacitances Cgs and Cgd of semiconductor element 1a is discharged via gate resistor 26 and switch 25b. Gate charge amount Qga gradually decreases from Qh, and gate voltage Vga gradually decreases from on-bias voltage Vp toward off-bias voltage Vn. When gate voltage Vga becomes less than gate threshold voltage Vth, semiconductor element 1a starts to be turned off.

When semiconductor element 1a is turned off, as shown in FIG. 4 (B), the freewheeling current starts to flow through the diode of semiconductor element 1a. Accordingly, drain voltage Vdsa and drain current Ida are maintained at constant values without being changed by turning-off of semiconductor element 1a.

A period from time t3 to a time t4 corresponds to dead time Td. In dead time Td, the diode of semiconductor element 1a performs the freewheeling operation, and thus gate charge amount Qga does not decrease to 0 and is maintained at Qa. Qa corresponds to a charge amount stored in dead time Td (the period from time t1 to time t2) after the turning-off of semiconductor element 1b. That is, it can be seen that gate charge amount Qgb of semiconductor element 1b in the SW operation decreases to 0 after the turning-off, whereas gate charge amount Qga of semiconductor element 1a in the freewheeling operation does not decrease to 0 after the turning-off.

When gate command signal GSWb transitions from the L level to the H level at time t4, semiconductor element 1b is turned on. Specifically, gate drive circuit 10b turns on switch 15a and turns off switch 15b in response to gate command signal GSWb at the H level, and thereby switches the voltage to be applied to the gate of semiconductor element 1b from off-bias voltage Vn to on-bias voltage Vp.

Thereby, gate current Igb flows from power supply node 12 to the gate of semiconductor element 1b via gate resistor 26, and gate parasitic capacitances Cgs and Cgd are charged. Gate charge amount Qgb gradually increases from 0 and reaches Qh. When charging is completed, gate current Igb stops flowing. Thereafter, on-bias voltage Vp is continuously applied to the gate of semiconductor element 1b, and thus semiconductor element 1b is maintained in the ON state. As shown in FIG. 4 (A), a forward current flows between the drain and the source of semiconductor element 1b, and semiconductor element 1b performs the SW operation.

In response to turning-on of semiconductor element 1b, drain current Idb starts to flow through semiconductor element 1b. In response to drain current Idb starting to flow, drain voltage Vdsb of semiconductor element 1b starts to decrease, and drain current Idb thereof starts to increase. Thereby, the freewheeling current flowing through the diode of semiconductor element 1a decreases, and drain voltage Vdsa starts to increase. Since a reverse voltage is applied to the diode of semiconductor element la, an instantaneous recovery current flows through the diode, and thereafter the diode is turned off.

Through a recovery operation of the diode of semiconductor element 1a, drain voltage Vdsa steeply changes. While change dv/dt in drain voltage Vdsa with respect to time occurs, a displacement current (Cgd×dv/dt) flows through gate-drain capacitance Cgd of semiconductor element 1a. Since this displacement current flows through gate resistor 26, gate voltage Vga increases. Further, since gate parasitic capacitances Cgd and Cgs are discharged by the displacement current, gate charge amount Qga decreases from Qa to 0.

Operation waveforms when semiconductor element 1b performs the SW operation and semiconductor element 1a performs the freewheeling operation in the case of phase current IL<0 have been described above. In the case of phase current IL>0, semiconductor element 1a performs the SW operation and semiconductor element 1b performs the freewheeling operation, and operation waveforms thereof can be considered to be similar to those in FIG. 5.

### Self Turning-On Phenomenon

As shown in FIG. 5, when semiconductor element 1b that performs the SW operation is turned on (at time t4 in FIG. 5), steep voltage change dv/dt is applied between the drain and the source of semiconductor element 1a that performs the freewheeling operation. Thereby, the displacement current (Cgd dv/dt) flows through gate resistor 26, and thus gate voltage Vga is raised instantaneously. When gate voltage Vga exceeds gate threshold voltage Vth, turned-off semiconductor element 1a may be erroneously turned on. Such a phenomenon in which semiconductor element 1a is turned on by itself is called “self turning-on”.

It should be noted that, when semiconductor element 1a that performs the freewheeling operation is turned on (at time t2 in FIG. 5), drain voltage Vdsb of semiconductor element 1b that performs the SW operation does not change, and thus self turning-on of semiconductor element 1b does not occur.

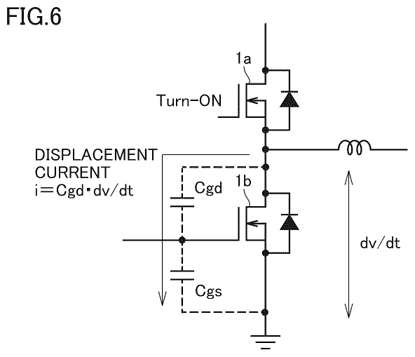

In leg 12U constituted by a bridge circuit, self turning-on may occur also when semiconductor element 1a performs the SW operation and semiconductor element 1b performs the freewheeling operation. FIG. 6 is a diagram illustrating self turning-on of semiconductor element 1b.

As shown in FIG. 3 (B), when semiconductor elements 1a and 1b are set to the OFF state, a freewheeling current flows through the diode of semiconductor element 1b. When semiconductor element 1a is turned on in this state, steep voltage change dv/dt occurs between the drain and the source of semiconductor element 1b, through a recovery operation of the diode of semiconductor element 1b. During this period, drain voltage Vdsb linearly increases from 0 to VDC. While dv/dt occurs, a displacement current i (=Cgd×dv/dt) flows through gate parasitic capacitances Cgd and Cgs of semiconductor element 1a, and thereby gate-source capacitance Cgs is instantaneously charged. As a result, gate voltage Vga increases, and semiconductor element 1b is self turned.

When self turning-on of semiconductor element 1b occurs, semiconductor elements 1a and 1b are simultaneously turned on, and thus an excessive short-circuit current may instantaneously flow from DC positive bus PL to DC negative bus NL. A loss caused by the short-circuit current may destroy semiconductor elements 1a and 1b.

### Exemplary Configuration of Gate Drive Circuit According to the First Embodiment

As described above, when semiconductor element 1 that performs the SW operation is turned on, self turning-on of semiconductor element 1 that performs the freewheeling operation may occur. Therefore, if an increase in gate voltage Vg of semiconductor element 1 that performs the freewheeling operation can be suppressed in accordance with timing at which semiconductor element 1 that performs the SW operation is turned on, occurrence of the self turning-on of semiconductor element 1 can be prevented.

Here, focusing on the operation waveforms of semiconductor elements 1a and 1b shown in FIG. 5, it can be seen that the waveforms of gate current Ig and gate charge amount Qg are different between semiconductor element 1b that performs the SW operation and semiconductor element 1b that performs the freewheeling operation.

Specifically, in semiconductor element 1b that performs the SW operation, gate current Igb temporarily flows when semiconductor element 1b is turned on and turned off, whereas gate current Iga does not flow when semiconductor element 1a is turned on and turned off. On the other hand, in semiconductor element 1a that performs the freewheeling operation, gate current Iga temporarily flows not only when semiconductor element 1a is turned on and turned off, but also when semiconductor element 1b is turned on and turned off.

Further, in semiconductor element 1b that performs the SW operation, gate charge amount Qgb decreases to 0 at turning-off. On the other hand, in semiconductor element 1a that performs the freewheeling operation, gate charge amount Qga is set to Qa at turning-off and does not decrease to 0. It should be noted that gate charge amount Qga of semiconductor element 1a decreases to 0 in response to turning-on of semiconductor element 1b.

Therefore, whether semiconductor element 1 performs the SW operation or performs the freewheeling operation can be determined from the waveform of gate current Ig or gate charge amount Qg. Thus, if it can be determined that semiconductor element 1 performs the freewheeling operation, it is possible to suppress an instantaneous increase in gate voltage Vg at timing at which the other semiconductor element 1 is turned on, that is, at timing at which the diode of semiconductor element 1 performs the recovery operation. It should be noted that the timing at which the diode of semiconductor element 1 performs the recovery operation can be known from timing at which gate charge amount Qg decreases from Qa to 0.

Gate drive circuit 10 according to the first embodiment is configured to determine whether or not the diode of corresponding semiconductor element 1 performs the freewheeling operation based on the waveform of gate charge amount Qg of semiconductor element 1. Then, when it is determined that the diode of corresponding semiconductor element 1 performs the freewheeling operation, gate drive circuit 10 is configured to detect the timing at which the diode of semiconductor element 1 performs the recovery operation from the waveform of gate charge amount Qg, and temporarily decrease off-bias voltage Vn to be applied to the gate of semiconductor element 1 in accordance with the detected timing.

Hereinafter, a detailed configuration of gate drive circuit 10 according to the first embodiment will be described. Since gate drive circuits 10a to 10f basically have a common configuration, the configuration of gate drive circuit 10a will be representatively described below.

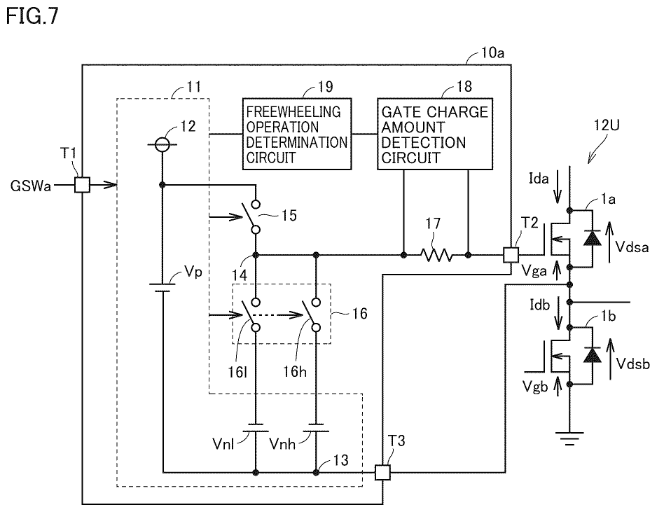

FIG. 7 is a block diagram showing an exemplary configuration of gate drive circuit 10a according to the first embodiment. As shown in FIG. 7, gate drive circuit 10a includes input terminal T1, output terminals T2 and T3, a control circuit 11, a switch 15, an off-bias switching circuit 16, a gate charge amount detection circuit 18, and a freewheeling operation determination circuit 19.

Input terminal T1 is connected to control device 130 (see FIG. 1). Input terminal T1 transfers gate command signal GSWa supplied from control device 130 to control circuit 11. Output terminal T2 is connected to the gate serving as the control electrode of semiconductor element 1a. Output terminal T3 is connected to the source serving as the main electrode on the low potential side of semiconductor element 1a, and to reference node 13.

Control circuit 11 has on-bias power supply Vp for generating on-bias voltage Vp to be applied to the gate of semiconductor element 1a, an off-bias power supply Vnh for generating an off-bias voltage Vnh to be applied to the gate of semiconductor element 1a, and an off-bias power supply Vnl for generating an off-bias voltage Vnl. Control circuit 11 is different from control circuit 21 shown in FIG. 2 in that it has two types of off-bias power supplies Vnh and Vnl.

On-bias voltage Vp is a voltage higher than gate threshold voltage Vth of semiconductor element 1. Off-bias voltages Vnh and Vnl are voltages less than gate threshold voltage Vth of semiconductor element 1. Off-bias voltage Vnh is higher than off-bias voltage Vnl. When gate threshold voltage Vth of an ordinary normally-off MOSFET and IGBT is about 2 to 7 V, on-bias voltage Vp can be set to 15 to 20 V, for example. Off-bias voltage Vnh can be set to 0 to −10 V, for example. Off-bias voltage Vnl can be set to −2 to −15 V, for example. It should be noted that off-bias voltages Vnh and Vnl have a relation that the magnitude (absolute value) of Vnh is always smaller than the magnitude of Vnl. Off-bias voltage Vnh corresponds to one embodiment of a “first value”, and off-bias voltage Vnl corresponds to one embodiment of a “second value”.

On-bias power supply Vp has the positive electrode terminal connected to power supply node 12, and the negative electrode terminal connected to reference node 13. Off-bias power supply Vnh has a positive electrode terminal connected to reference node 13, and a negative electrode terminal electrically connected to output node 14. Off-bias power supply Vnl has a positive electrode terminal connected to reference node 13, and a negative electrode terminal connected to output node 14.

Switch 15 is connected between power supply node 12 and output node 14.

Off-bias switching circuit 16 has a switch 16h and a switch 16l. Switch 16h is connected between output node 14 and the negative electrode terminal of off-bias power supply Vnh. Switch 16l is connected between output node 14 and the negative electrode terminal of off-bias power supply Vnl. A gate resistor 17 is connected between output node 14 and output terminal T2.

Gate charge amount detection circuit 18 detects gate charge amount Qg by time-integrating gate current Ig flowing through gate resistor 17. In the example in FIG. 7, gate charge amount detection circuit 18 is configured to obtain gate current Ig from an inter-terminal voltage of gate resistor 17, and time-integrate gate current Ig to detect gate charge amount Qg. There are various methods of integrating gate current Ig, such as an integration method using an operational amplifier, an integration method using a CR filter, and the like. The method of detecting gate current Ig may be any method. Gate charge amount detection circuit 18 outputs a detection value of gate charge amount Qga to freewheeling operation determination circuit 19.

Freewheeling operation determination circuit 19 determines whether or not the diode of semiconductor element 1a performs the freewheeling operation based on the detection value of gate charge amount Qg. Specifically, freewheeling operation determination circuit 19 has a predetermined threshold value Qb, and compares threshold value Qb with the detection value of gate charge amount Qg to determine whether or not the diode of semiconductor element 1a performs the freewheeling operation.

Control circuit 11 selectively turns on/off switch 15 and off-bias switching circuit 16 in response to gate command signal GSWa. Specifically, when gate command signal GSWa is at the H level, control circuit 11 turns on switch 15 and turns off off-bias switching circuit 16. Thereby, output node 14 is connected to power supply node 12, and thus on-bias power supply Vp is connected between output terminals T2 and T3. As a result, on-bias voltage Vp is applied between the gate and the source of semiconductor element 1a.

On the other hand, when gate command signal GSwa is at the L level, control circuit 11 turns off switch 15 and turns on off-bias switching circuit 16. Off-bias switching circuit 16 selectively turns on switches 16h and 16l based on a determination result supplied from freewheeling operation determination circuit 19. When switch 16h is turned on, output node 14 is connected to the negative electrode terminal of off-bias power supply Vnh, and thus off-bias power supply Vnh is connected between output terminals T2 and T3. As a result, off-bias voltage Vnh is applied between the gate and the source of semiconductor element 1a. When switch 16l is turned on, output node 14 is connected to the negative electrode terminal of off-bias power supply Vnl, and thus off-bias power supply Vnl is connected between output terminals T2 and T3. As a result, off-bias voltage Vnl is applied between the gate and the source of semiconductor element 1a.

That is, off-bias switching circuit 16 is configured to switch gate voltage Vga of semiconductor element 1a between off-bias voltage Vnh and off-bias voltage Vnl in accordance with the determination result of freewheeling operation determination circuit 19.

### Operation of Gate Drive Circuit According to the First Embodiment

Next, an operation of gate drive circuit 10a according to the first embodiment will be described.

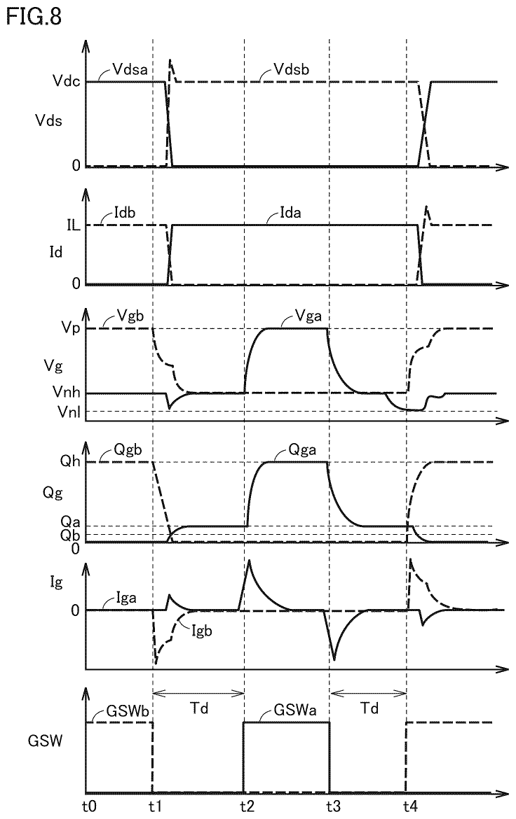

FIG. 8 is a time chart showing operations of semiconductor elements 1a and 1b. FIG. 8 shows waveforms of drain voltage Vds, drain current Id, gate voltage Vg, gate charge amount Qg, gate current Ig, and gate command signal GSW of semiconductor elements 1a and 1b. In each waveform, a solid line indicates a waveform of P-side semiconductor element 1a, and a broken line indicates a waveform of N-side semiconductor element 1b.

The time chart shown in FIG. 8 is different from the time chart shown in FIG. 5 in the waveform of gate voltage Vga of semiconductor element 1b. Since the other waveforms are the same as those shown in FIG. 5, detailed description thereof will be omitted.

As shown in FIG. 8, at time t0, gate command signal GSWa is at the L level, and gate command signal GSWb is at the H level. In gate drive circuit 10a, control circuit 11 turns off switch 15 and turns on off-bias switching circuit 16 in response to gate command signal GSWa at the L level. Gate charge amount Qga of semiconductor element 1a is set to 0. Freewheeling operation determination circuit 19 compares gate charge amount Qga with threshold value Qb. Threshold value Qb is set to a value that is greater than 0 and is less than or equal to a gate charge amount Qa in dead time Td. Since Qga<Qb, freewheeling operation determination circuit 19 determines that semiconductor element 1a is not in the freewheeling operation.

In response to determination that semiconductor element 1a is not in the freewheeling operation, off-bias switching circuit 16 turns on switch 16h and turns off switch 16l, and thereby applies off-bias voltage Vnh to the gate of semiconductor element 1a. Gate voltage Vga of semiconductor element 1a is set to off-bias voltage Vnh, and semiconductor element 1a is set to the OFF state. Accordingly, drain current Ida is set as Ida=0, and drain voltage Vdsa is set as Vdsa=VDC. VDC corresponds to the inter-terminal voltage of DC power supply 110. Since gate parasitic capacitances Cgd and Cgs of semiconductor element 1b are discharged, gate charge amount Qga is set to 0.

When gate command signal GSWb transitions from the H level to the L level at time t1, semiconductor element 1b is turned off. In gate drive circuit 10b, control circuit 11 turns off switch 15 and turns on off-bias switching circuit 16 in response to gate command signal GSWb at the L level. Off-bias switching circuit 16 first turns on switch 16h and turns off switch 16l, and thereby applies off-bias voltage Vnh to the gate of semiconductor element 1b. Since gate voltage Vgb of semiconductor element 1b is set to off-bias voltage Vnh, the charge stored in gate parasitic capacitances Cgs and Cgd of semiconductor element 1b is discharged, and thus gate charge amount Qgb gradually decreases from Qh. In response to completion of discharging of gate parasitic capacitances Cgs and Cgd, gate charge amount Qgb is set to 0.

Freewheeling operation determination circuit 19 compares gate charge amount Qgb with threshold value Qb. Since Qgb<Qb, freewheeling operation determination circuit 19 determines that the diode of semiconductor element 1b is not in the freewheeling operation. In response to determination that the diode of semiconductor element 1b is not in the freewheeling operation, off-bias switching circuit 16 maintains switch 16h in the ON state, and thereby continues to apply off-bias voltage Vnh to the gate of semiconductor element 1b.

In response to turning-off of semiconductor element 1b, a freewheeling current flows through the diode of semiconductor element 1a. In a transient period in which drain voltage Vdsa steeply changes in response to the freewheeling current starting to flow through the diode, a displacement current (Cgd×dv/dt) flows through gate-drain capacitance Cgd of semiconductor element 1a. Since this displacement current flows through gate resistor 26, gate voltage Vga decreases. Further, since gate parasitic capacitances Cgd and Cgs are charged by the displacement current, gate charge amount Qga increases from 0 to Qa.

The period from time t1 to time t2 corresponds to dead time Td. In dead time Td, the freewheeling current continues to flow through the diode of semiconductor element 1a.

When gate command signal GSWa transitions from the L level to the H level at time t2, semiconductor element 1a is turned on. Specifically, gate drive circuit 10a turns on switch 15 and turns off off-bias switching circuit 16 in response to gate command signal GSWa at the H level, and thereby switches a voltage to be applied to the gate of semiconductor element 1a from off-bias voltage Vnh to off-bias voltage Vp. Gate current Iga flows from power supply node 12 to the gate of semiconductor element 1a via gate resistor 17. Since gate parasitic capacitances Cgs and Cgd are charged, gate charge amount Qga gradually increases from Qa and reaches Qh. The freewheeling current flows between the drain and the source of semiconductor element la, and semiconductor element 1a performs the freewheeling operation.

When gate command signal GSWa transitions from the H level to the L level at time t3, semiconductor element 1a is turned off. In gate drive circuit 10a, control circuit 11 turns off switch 15 and turns on off-bias switching circuit 16 in response to gate command signal GSWa at the L level. Off-bias switching circuit 16 first turns on switch 16h and turns off switch 16l, and thereby applies off-bias voltage Vnh to the gate of semiconductor element 1a. Since gate voltage Vga of semiconductor element la is set to off-bias voltage Vnh, the charge stored in gate parasitic capacitances Cgs and Cgd of semiconductor element 1a are discharged, and thus gate charge amount Qga gradually decreases from Qh.

Gate voltage Vga gradually decreases from on-bias voltage Vp toward off-bias voltage Vn. When gate voltage Vga becomes less than gate threshold voltage Vth, semiconductor element 1a starts to be turned off. When semiconductor element 1a is turned off, the freewheeling current starts to flow through the diode of semiconductor element 1a. Accordingly, drain voltage Vdsa and drain current Ida are maintained at constant values without being changed by turning-off of semiconductor element 1a.

Here, as described in FIG. 5, since the diode of semiconductor element 1a performs the freewheeling operation in dead time Td from time t3 to time t4, gate charge amount Qga does not decrease to 0 and is maintained at Qa. Qa corresponds to the charge amount stored in dead time Td (the period from time t1 to time t2) after the turning-off of semiconductor element 1b.

Freewheeling operation determination circuit 19 compares gate charge amount Qga in dead time Td with threshold value Qb. Since Qga (=Qa)>Qb, freewheeling operation determination circuit 19 determines that the diode of semiconductor element la is in the freewheeling operation. In response to determination that the diode of semiconductor element 1a is in the freewheeling operation, off-bias switching circuit 16 turns off switch 16h and turns on switch 16l. Thereby, gate voltage Vga of semiconductor element 1a is switched from off-bias voltage Vnh to off-bias voltage Vnl.

It should be noted that timing of switching gate voltage Vga from off-bias voltage Vnh to off-bias voltage Vnl is preferably timing after gate current Iga finishes flowing in response to the turning-off of semiconductor element 1a (at time t3). This timing can be obtained based on gate parasitic capacitances Cgd and Cgs of semiconductor element 1a and a time constant of gate resistor 17. Alternatively, the timing of switching gate voltage Vga can be obtained based on a fall time Tf of semiconductor element 1a or the like described in a data sheet or the like. Fall time Tf represents a time taken for drain voltage Vdsa to increase from 10% to 90% of a maximum voltage Vdc when semiconductor element 1a is turned off.

When gate command signal GSWb transitions from the L level to the H level at time t4, semiconductor element 1b is turned on. Specifically, gate drive circuit 10b turns on switch 15 and turns off off-bias switching circuit 16 in response to gate command signal GSWb at the H level, and thereby switches a voltage to be applied to the gate of semiconductor element 1b from off-bias voltage Vnh to off-bias voltage Vp.

When drain current Idb starts to flow through semiconductor element 1b in response to turning-on of semiconductor element 1b, drain voltage Vdsa of semiconductor element 1a steeply changes through a recovery operation of the diode of semiconductor element 1a. While change dv/dt in drain voltage Vdsa with respect to time occurs, a displacement current (Cgd×dv/dt) flows through gate-drain capacitance Cgd of semiconductor element 1a. Since this displacement current flows through gate resistor 17, gate voltage Vga increases, and gate charge amount Qga decreases from Qa to 0.

However, since gate voltage Vga of semiconductor element 1a is switched from off-bias voltage Vnh to off-bias voltage Vnl in dead time Td from time t3 to time t4, gate voltage Vga does not exceed gate threshold voltage Vth even if gate voltage Vga instantaneously increases after time t4. Therefore, self turning of semiconductor element 1a can be prevented in advance.

In gate drive circuit 10a, freewheeling operation determination circuit 19 compares gate charge amount Qga with threshold value Qb. Since Qga (=0)<Qb, freewheeling operation determination circuit 19 determines that semiconductor element la has finished the freewheeling operation. In response to determination that semiconductor element 1a has finished the freewheeling operation, off-bias switching circuit 16 turns off switch 16l and turns on switch 16h. Thereby, gate voltage Vga of semiconductor element 1a is switched from off-bias voltage Vnl to off-bias voltage Vnh.

That is, gate drive circuit 10a temporarily decreases gate voltage Vga of semiconductor element 1a from off-bias voltage Vnh to off-bias voltage Vnl in accordance with timing at which the diode of semiconductor element 1a performs the recovery operation. This can suppress gate voltage Vga from instantaneously increasing in response to the recovery operation of the diode and exceeding gate threshold voltage Vth.

Here, an oxide film of the gate of semiconductor element 1 has a life in accordance with the magnitude of the voltage applied between the gate and the source (that is, gate voltage Vg). In particular, when the magnitude of gate voltage Vg exceeds a maximum voltage to be applied between the gate and the source, the oxide film may be destroyed, or aging may occur due to an increase in ions inside the oxide film. In order to suppress the progress of deterioration of the oxide film, it is necessary to reduce the magnitude of gate voltage Vg to relax an electric field to be applied to the oxide film, or to shorten a time of applying gate voltage Vg.

Accordingly, when the off-bias voltage is fixed to Vnl (for example, −10 to−20 V), self turning-on of semiconductor element 1a can be suppressed, but there is a concern that deterioration of the oxide film of the gate of semiconductor element 1a may progress. In gate drive circuit 10a according to the first embodiment, the off-bias voltage is temporarily set to Vnl only at the timing at which the diode of semiconductor element 1a performs the recovery operation, and the off-bias voltage is set to Vnh (for example, 0 to −5 V) having a magnitude smaller than that of Vnl at timing other than that timing. Thus, the magnitude of gate voltage Vga in a period in which the diode of semiconductor element 1a does not perform the recovery operation can be reduced. Therefore, it is possible to suppress the progress of deterioration of the oxide film of the gate while preventing the self turning-on of semiconductor element 1a.

Operation waveforms when semiconductor element 1b performs the SW operation and semiconductor element 1a performs the freewheeling operation in the case of phase current IL<0 have been described above. In the case of phase current IL>0, semiconductor element 1a performs the SW operation and semiconductor element 1b performs the freewheeling operation, and operation waveforms thereof can be considered to be similar to those in FIG. 8.

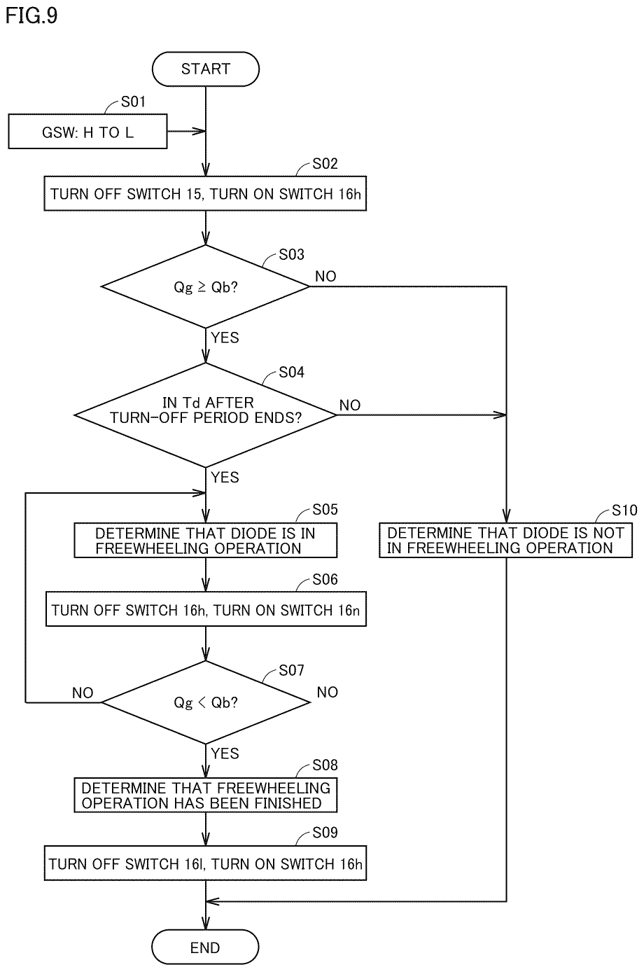

FIG. 9 is a flowchart showing an operation of gate drive circuit 10 according to the first embodiment. FIG. 9 shows the operation of gate drive circuit 10 when corresponding semiconductor element 1 is turned off in accordance with gate command signal GSW at the L level (an OFF command) from control device 130. Since determination of whether or not semiconductor element 1 performs the freewheeling operation when gate command signal GSW at the H level (an ON command) is received does not affect switching of the off-bias voltage, the description thereof will be omitted.

When semiconductor element 1 is in the ON state, on-bias voltage Vp is applied to the gate of semiconductor element 1. When gate drive circuit 10 receives gate command signal GSW at the L level (an OFF command) from control device 130 (step S01) in this state, control circuit 11 turns off switch 15 and turns on off-bias switching circuit 16. Off-bias switching circuit 16 turns on switch 16h and turns off switch 16l (step S02). Thereby, off-bias voltage Vnh is applied to the gate of semiconductor element 1. Since gate voltage Vg of semiconductor element 1 is set to off-bias voltage Vnh, the charge stored in gate parasitic capacitances Cgs and Cgd of semiconductor element 1 is discharged, and gate charge amount Qg gradually decreases from Qh. When gate voltage Vga gradually decreases toward off-bias voltage Vnh and becomes less than gate threshold voltage Vth, semiconductor element 1 starts to be turned off.

Freewheeling operation determination circuit 19 compares gate charge amount Qg detected by gate charge amount detection circuit 18 with threshold value Qb (step S03). When gate charge amount Qg is less than threshold value Qb (when it is determined as NO in S03), freewheeling operation determination circuit 19 determines that the diode of semiconductor element 1 is not in the freewheeling operation (step S10).

On the other hand, when gate charge amount Qg is more than or equal to threshold value Qb (when it is determined as YES in S03), freewheeling operation determination circuit 19 subsequently determines whether or not current timing is in dead time Td after a turn-off period of semiconductor element 1 (step S04). The turn-off period can be obtained based on gate parasitic capacitances Cgd and Cgs of semiconductor element 1 and the time constant of gate resistor 17. Alternatively, the turn-off period can be obtained based on fall time Tf of semiconductor element 1a or the like described in the data sheet or the like.

When the current timing is in the turn-off period of semiconductor element 1, it is determined as NO in S04. In this case, freewheeling operation determination circuit 19 determines that the diode of semiconductor element 1 is not in the freewheeling operation (step S10).

On the other hand, when the current timing is in dead time Td after the turn-off period of semiconductor element 1 (when it is determined as YES in S04), freewheeling operation determination circuit 19 determines that the diode of semiconductor element 1 is in the freewheeling operation (step S05). In this case, off-bias switching circuit 16 turns off switch 16h and turns on switch 16l (step S06). Thereby, gate voltage Vg of semiconductor element 1 is switched from off-bias voltage Vnh to off-bias voltage Vnl.

When another semiconductor element 1 connected in series to semiconductor element 1 is turned on in dead time Td, the diode of semiconductor element 1 performs a recovery operation, and thus drain voltage Vds of semiconductor element 1 steeply changes. While change dv/dt in drain voltage Vds with respect to time occurs, a displacement current (Cgd×dv/dt) flows through gate-drain capacitance Cgd of semiconductor element 1. Accordingly, gate voltage Vg increases, and gate charge amount Qg decreases from Qa to 0.

Freewheeling operation determination circuit 19 compares gate charge amount Qb detected by gate charge amount detection circuit 18 with threshold value Qb (step S07). When gate charge amount Qg is more than or equal to threshold value Qb (when it is determined as NO in S07), freewheeling operation determination circuit 19 determines that the diode of semiconductor element 1 is in the freewheeling operation (step S05). Therefore, off-bias switching circuit 16 continues to turn on switch 16l (step S06) to maintain gate voltage Vg of semiconductor element 1 at off-bias voltage Vnl.

On the other hand, when gate charge amount Qg is less than threshold value Qb (when it is determined as YES in S07), freewheeling operation determination circuit 19 determines that semiconductor element 1 has finished the freewheeling operation (step S08). In response to determination that semiconductor element 1 has finished the freewheeling operation, off-bias switching circuit 16 turns off switch 16l and turns on switch 16h (step S09). Thereby, gate voltage Vg of semiconductor element 1 is switched from off-bias voltage Vnl to off-bias voltage Vnh.

It should be noted that, although threshold value Qb is used for both the process of determining whether or not semiconductor element 1 is in the freewheeling operation (step S03) and the process of determining whether or not semiconductor element 1 has finished the freewheeling operation (step S07) in the flowchart in FIG. 9, different threshold values may be used for these two processes in accordance with characteristics of semiconductor element 1. In order to reliably prevent the self turning-on of semiconductor element 1, it is desirable to determine a threshold value in full consideration of timing of the recovery operation of the diode of semiconductor element 1 and timing of switching from off-bias voltage Vnl to off-bias voltage Vnh. Therefore, determining a threshold value used for each process in consideration of the characteristics of semiconductor element 1 is further effective in preventing self turning-on.

### Effects in the First Embodiment

As described above, gate drive circuit 10 according to the first embodiment is configured to determine whether or not the diode of corresponding semiconductor element 1 performs the freewheeling operation based on the detection value of gate charge amount Qg of semiconductor element 1. Therefore, whether or not the diode of the semiconductor element performs the freewheeling operation can be determined with a simple configuration, with no need to install a sense terminal for detecting a flow direction of a current in each semiconductor element 1.

Further, when it is determined that the diode of semiconductor element 1 performs the freewheeling operation, gate drive circuit 10 can temporarily decrease the off-bias voltage, based on the detection value of gate charge amount Qg, in accordance with the timing at which the diode of semiconductor element 1 performs the recovery operation in response to turning-on of other semiconductor element 1 connected in series to semiconductor element 1. Thus, the off-bias voltage can be decreased without excess or deficiency with respect to a time required to turn on other semiconductor element 1. Further, a signal or the like for sensing timing of the turning-on of other semiconductor element 1 is not required. Therefore, off-bias switching circuit 16, which is a circuit for suppressing the self turning-on of semiconductor element 1, can be activated at appropriate timing, with a simple configuration. As a result, it is possible to suppress the progress of deterioration of the oxide film of the gate while preventing the self turning-on of semiconductor element 1.

### Second Embodiment

A second embodiment will describe an exemplary circuit configuration of gate drive circuit 10 according to the first embodiment.

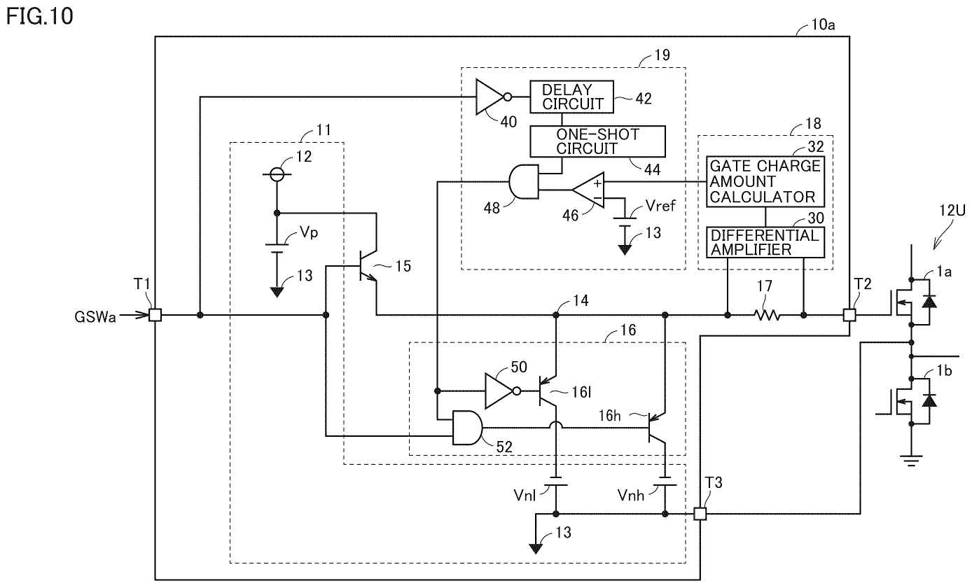

FIG. 10 is a diagram showing an exemplary circuit configuration of gate drive circuit 10a shown in FIG. 7. As shown in FIG. 10, switch 15 is constituted by an NPN transistor. The NPN transistor has a collector connected to power supply node 12, an emitter connected to output node 14, and a base connected to input terminal T1. The NPN transistor is turned on when it receives gate command signal GSWa at the H level (an ON command) at its base, and is turned off when it receives gate command signal GSWa at the L level (an OFF command) at its base.

Gate charge amount detection circuit 18 includes a differential amplifier 30 and a gate charge amount calculator 32. Differential amplifier 30 functions as a voltage detector that detects the inter-terminal voltage of gate resistor 17. Gate charge amount calculator 32 detects gate current Ig based on the inter-terminal voltage of gate resistor 17 and a resistance value of gate resistor 17, and integrates detected gate current Ig to obtain gate charge amount Qg.

Freewheeling operation determination circuit 19 includes a negative (NOT) circuit 40, a delay circuit 42, a one-shot circuit 44, a comparator 46, and a logical product (AND) circuit 48.

Comparator 46 compares gate charge amount Qga obtained by gate charge amount calculator 32 with a reference voltage Vref. Reference voltage Vref is a voltage value corresponding to threshold value Qb. When gate charge amount Qga is greater than reference voltage Vref (that is, threshold value Qb), comparator 46 outputs a signal at the H level. When gate charge amount Qga is smaller than reference voltage Vref (threshold value Qb), comparator 46 outputs a signal at the L level.

NOT circuit 40 outputs an inversion signal of gate command signal GSWa inputted to input terminal T1.

Delay circuit 42 receives the output signal of NOT circuit 40, and delays the output signal by a predetermined delay time t0 generate a delay signal. Since gate charge amount Qga is set to Qh and is greater than threshold value Qb immediately after gate command signal GSWa transitions from the H level to the L level, it may be erroneously determined that the diode of semiconductor element 1a performs the freewheeling operation. Accordingly, the delay time in delay circuit 42 is set based on a turn-off time of semiconductor element 1. Further, when semiconductor element la performs the SW operation, gate charge amount Qga decreases from Qh to 0 in response to turning-off of semiconductor element 1a, and thus the delay time is provided to also wait for gate charge amount Qga to become smaller than threshold value Qb.

One-shot circuit 44 generates a one-shot pulse signal in response to transition of the output signal of NOT circuit 40 from the L level to the H level. That is, when an OFF command is received from control device 130, one-shot circuit 44 generates the one-shot pulse signal delayed by the turn-off time of semiconductor element 1. The pulse signal has a pulse width that is set based on dead time Td. The pulse width of the pulse signal can be adjusted by a CR constant in one-shot circuit 44 to be maintained for dead time Td.

AND circuit 48 receives the pulse signal of one-shot circuit 44 at its first input terminal, and receives the output signal of comparator 46 at its second input terminal. AND circuit 48 calculates a logical sum of the two input signals, and outputs a calculation result. When gate charge amount Qga is greater than threshold value Qb, an output signal of AND circuit 48 is set to the H level only for a period corresponding to dead time Td, delayed from timing at which the OFF command is received from control device 130, by the turn-off time of semiconductor element 1. The output signal of AND circuit 48 is inputted to off-bias switching circuit 16, and functions as a signal for switching gate voltage Vg of semiconductor element 1 from off-bias voltage Vh to off-bias voltage Vnl.

Off-bias switching circuit 16 includes switches 16l and 16h constituted by PNP transistors, a NOT circuit 50, and an AND circuit 52.

The PNP transistor constituting switch 16h has an emitter connected to output node 14, a collector connected to the negative electrode terminal of off-bias power supply Vnh, and a base connected to an output terminal of AND circuit 52.

The PNP transistor constituting switch 16l has an emitter connected to output node 14, a collector connected to the negative electrode terminal of off-bias power supply Vnl, and a base connected to an output terminal of NOT circuit 50.

NOT circuit 50 generates an inversion signal of the output signal of AND circuit 48 included in freewheeling operation determination circuit 19, and inputs the generated inversion signal to the base of switch 16l.

AND circuit 52 receives the output signal of AND circuit 48 at its first input terminal, and receives gate command signal GSWa at its second input terminal. AND circuit 52 calculates a logical product of these two input signals, and inputs a calculation result to the base of switch 16h.

Switch 16l is turned on for a period in which an output signal of NOT circuit 50 is set to the L level, that is, for a period in which the output signal of AND circuit 48 is set to the H level. That is, when gate charge amount Qga is greater than threshold value Qb, switch 16l is turned on only for the period corresponding to dead time Td, delayed from the timing at which the OFF command is received from control device 130, by the turn-off time of semiconductor element 1. In response to turning-on of switch 16l, off-bias voltage Vnl is applied to the gate of semiconductor element 1a.

Switch 16h is turned on when gate command signal SWa is at the L level and switch 16l is turned off. In response to turning-on of switch 16h, off-bias voltage Vnh is applied to the gate of semiconductor element 1a.

Although FIG. 10 illustrates a configuration in which a push-pull circuit with bipolar transistors is used as each of switches 16l and 16h, switches 16l and 16h are not limited thereto. For example, a push-pull circuit with MOSFETs may be used as each of switches 16l and 16h.

### Third Embodiment.

The first embodiment has described the configuration in which gate drive circuit 10 has two types of off-bias power supplies Vnh and Vnl, and gate voltage Vg of semiconductor element 1 is switched between off-bias voltage Vnh and off-bias voltage Vnl in accordance with the determination result of freewheeling operation determination circuit 19.

A third embodiment will describe a configuration in which an off-bias voltage is switched using one type of off-bias power supply Vn.

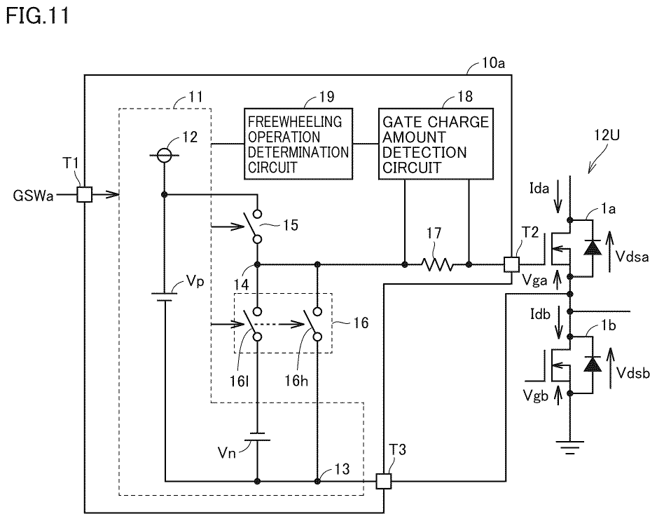

FIG. 11 is a block diagram showing an exemplary configuration of gate drive circuit 10a according to the third embodiment. Gate drive circuit 10a drives P-side semiconductor element 1a. Since gate drive circuit 10a to drive P-side semiconductor element 1a and gate drive circuit 10b to drive N-side semiconductor element 1b basically have a common configuration, the configuration of gate drive circuit 10a will be representatively described below.

As shown in FIG. 11, gate drive circuit 10a according to the third embodiment includes input terminal T1, output terminals T2 and T3, control circuit 11, switch 15, off-bias switching circuit 16, gate charge amount detection circuit 18, and freewheeling operation determination circuit 19.

Gate drive circuit 10a according to the third embodiment is different from gate drive circuit 10a according to the first embodiment shown in FIG. 7 in the configuration of control circuit 11. Control circuit 11 has on-bias power supply Vp for generating on-bias voltage Vp to be applied to the gate of semiconductor element 1a, and off-bias power supply Vn for generating off-bias voltage Vn to be applied to the gate of semiconductor element 1a. Control circuit 11 is different from control circuit 11 shown in FIG. 7 in that it has one type of off-bias power supply Vn.

On-bias power supply Vp has the positive electrode terminal connected to power supply node 12, and the negative electrode terminal connected to reference node 13. Off-bias power supply Vn has the positive electrode terminal connected to reference node 13, and the negative electrode terminal electrically connected to output node 14.

Off-bias switching circuit 16 has switch 16h connected between output node 14 and reference node 13, and switch 16l connected between output node 14 and the negative electrode terminal of off-bias power supply Vn.

Control circuit 11 selectively turns on/off switch 15 and off-bias switching circuit 16 in response to gate command signal GSWa. Specifically, when gate command signal GSWa is at the H level, control circuit 11 turns on switch 15 and turns off off-bias switching circuit 16. Thereby, output node 14 is connected to power supply node 12, and thus on-bias power supply Vp is connected between output terminals T2 and T3. As a result, on-bias voltage Vp is applied between the gate and the source of semiconductor element 1a.

On the other hand, when gate command signal GSwa is at the L level, control circuit 11 turns off switch 15 and turns on off-bias switching circuit 16. Off-bias switching circuit 16 selectively turns on switches 16h and 16l based on a determination result supplied from freewheeling operation determination circuit 19. When switch 16h is turned on, output node 14 is connected to reference node 13, and thus the gate and the source of semiconductor element 1a have the same potential. That is, 0 V is applied between the gate and the source of semiconductor element 1a.

When switch 16l is turned on, output node 14 is connected to the negative electrode terminal of off-bias power supply Vn, and thus off-bias power supply Vn is connected between output terminals T2 and T3. As a result, off-bias voltage Vn is applied between the gate and the source of semiconductor element 1a. Off-bias voltage Vn is a voltage less than 0 V.

That is, in the third embodiment, off-bias switching circuit 16 is configured to switch gate voltage Vga of semiconductor element 1a between 0 V and off-bias voltage Vn in accordance with the determination result of freewheeling operation determination circuit 19. By setting off-bias voltage Vnh to 0 V in this manner, only one type of off-bias power supply is required, and thus it is possible to reduce the size and cost of gate drive circuit 10a.

It should be noted that an operation of gate drive circuit 10 according to the third embodiment is the same as the operation of gate drive circuit 10 according to the first embodiment shown in FIGS. 8 and 9. That is, since the off-bias voltage is temporarily set to voltage Vn less than 0 only at timing at which the diode of semiconductor element 1 performs a recovery operation, and the off-bias voltage is set to 0 V at timing other than that timing, it is possible to suppress the progress of deterioration of the oxide film of the gate while preventing self turning-on of semiconductor element 1. Therefore, also in the third embodiment, the same effects as those in the first embodiment can be obtained.

Further, according to the third embodiment, since the magnitude of the off-bias voltage can be reduced as compared with the first embodiment, damage to the oxide film of the gate can be reduced.

### Fourth Embodiment.

The first embodiment has described the configuration in which off-bias switching circuit 16 switches gate voltage Vg of semiconductor element 1 between off-bias voltage Vnh and off-bias voltage Vnl in accordance with the determination result of freewheeling operation determination circuit 19.

A fourth embodiment will describe a configuration in which a resistance value of the gate resistor of semiconductor element 1 is switched in accordance with a determination result of freewheeling operation determination circuit 19. As described below, this configuration focuses on the fact that gate voltage Vg instantaneously increases in accordance with a displacement current flowing through the gate resistor during a recovery operation of the diode of semiconductor element 1. Gate drive circuit 10 is configured to temporarily decrease the resistance value of the gate resistor in accordance with timing of the recovery operation, and thereby suppress an increase in gate voltage Vg.

### Exemplary Configuration of Gate Drive Circuit According to the Fourth Embodiment

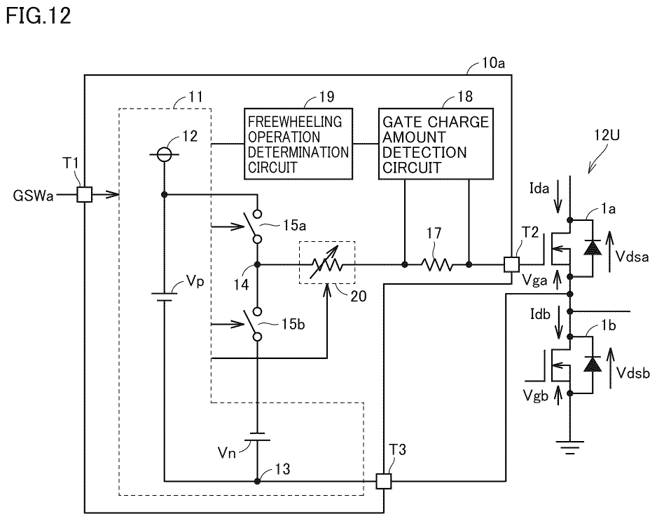

FIG. 12 is a block diagram showing an exemplary configuration of gate drive circuit 10a according to the fourth embodiment. Gate drive circuit 10a drives P-side semiconductor element 1a. Since gate drive circuit 10a to drive P-side semiconductor element 1a and gate drive circuit 10b to drive N-side semiconductor element 1b basically have a common configuration, the configuration of gate drive circuit 10a will be representatively described below.

As shown in FIG. 12, gate drive circuit 10a is configured to include input terminal T1, output terminals T2 and T3, control circuit 11, switches 15a and 15b, gate resistor 17, gate charge amount detection circuit 18, freewheeling operation determination circuit 19, and a gate resistor switching circuit 20.

Gate drive circuit 10a according to the third embodiment is different from gate drive circuit 10a according to the first embodiment shown in FIG. 7 in that it has switches 15a and 15b and gate resistor switching circuit 20 instead of switch 15 and off-bias switching circuit 16.

Control circuit 11 has on-bias power supply Vp for generating on-bias voltage Vp to be applied to the gate of semiconductor element 1a, and off-bias power supply Vn for generating off-bias voltage Vn to be applied to the gate of the semiconductor element 1a. On-bias power supply Vp has the positive electrode terminal connected to power supply node 12, and the negative electrode terminal connected to reference node 13. Off-bias power supply Vn has the positive electrode terminal connected to reference node 13, and the negative electrode terminal electrically connected to output node 14.

Switch 15a is connected between power supply node 12 and output node 14. Switch 15b is connected between output node 14 and the negative electrode terminal of off-bias power supply Vn. Gate resistor 17 and gate resistor switching circuit 20 are connected between output node 14 and output terminal T2.

Control circuit 11 selectively turns on/off switches 15a and 15b in response to gate command signal GSWa. Specifically, when gate command signal GSWa is at the H level, control circuit 11 turns on switch 15a and turns off switch 15b. Thereby, output node 14 is connected to power supply node 12, and thus on-bias power supply Vp is connected between output terminals T2 and T3. As a result, on-bias voltage Vp is applied between the gate and the source of semiconductor element 1a.

On the other hand, when gate command signal GSwa is at the L level, control circuit 11 turns off switch 15a and turns on switch 15b. Thereby, output node 14 is connected to the negative electrode terminal of off-bias power supply Vn, and thus off-bias power supply Vn is connected between output terminals T2 and T3. As a result, off-bias voltage Vn is applied between the gate and the source of semiconductor element 1a.

Gate charge amount detection circuit 18 is connected across gate resistor 17. Gate charge amount detection circuit 18 obtains gate current Iga from the inter-terminal voltage of gate resistor 17, and time-integrates gate current Iga to detect gate charge amount Qga. In order to obtain gate current Iga, the resistance value of gate resistor 17 is set to a fixed value Rg0.

Freewheeling operation determination circuit 19 determines whether or not the diode of semiconductor element 1a performs the freewheeling operation based on a detection value of gate charge amount Qga. As described above, freewheeling operation determination circuit 19 compares threshold value Qb with the detection value of gate charge amount Qg to determine whether or not the diode of semiconductor element 1a performs the freewheeling operation.

Gate resistor switching circuit 20 has a variable resistor, and is configured to change a resistance value in accordance with the determination result supplied from freewheeling operation determination circuit 19. As described later, gate resistor switching circuit 20 switches a resistance value of a gate resistor Rga of semiconductor element 1a between two types of resistance values, in accordance with the determination result of freewheeling operation determination circuit 19.

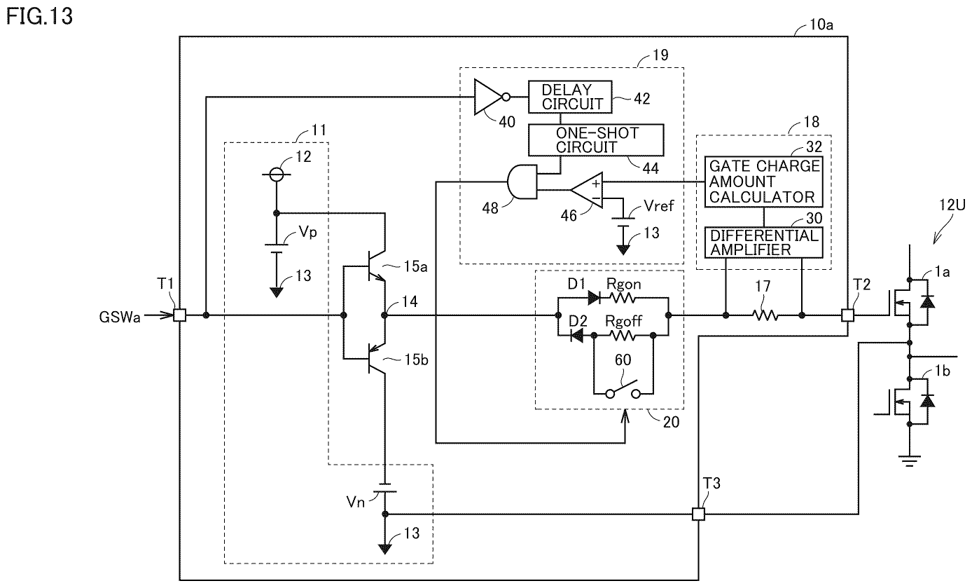

FIG. 13 is a diagram showing an exemplary circuit configuration of gate drive circuit 10a shown in FIG. 12. Since circuit configurations of gate charge amount detection circuit 18 and freewheeling operation determination circuit 19 are the same as those shown in FIG. 10, the description thereof will be omitted.

Switch 15a is constituted by an NPN transistor. The NPN transistor has a collector connected to power supply node 12, an emitter connected to output node 14, and a base connected to input terminal T1. The NPN transistor is turned on when it receives gate command signal GSWa at the H level (an ON command) at its base, and is turned off when it receives gate command signal GSWa at the L level (an OFF command) at its base.

Switch 15b is constituted by a PNP transistor. The PNP transistor has an emitter connected to output node 14, a collector connected to the negative electrode terminal of off-bias power supply Vn, and a base connected to input terminal T1. The PNP transistor is turned off when it receives gate command signal GSWa at the H level (an ON command) at its base, and is turned on when it receives gate command signal GSWa at the L level (an OFF command) at its base.

Gate resistor switching circuit 20 includes a gate resistor Rgon for turning on semiconductor element 1a, a gate resistor Rgoff for turning off semiconductor element la, diodes D1 and D2 for preventing backflow, and a switch 60.

Diode D1 and gate resistor Rgon are connected in series between output node 14 and gate resistor 17. Diode D1 allows gate current Ig in the positive direction (the direction in which gate current Ig charges gate parasitic capacitances Cgd and Cgs) to flow through gate resistor Rgon, and prevents gate current Ig in the negative direction (the direction in which gate current Ig discharges gate parasitic capacitances Cgd and Cgs) from flowing through gate resistor Rgon.

Diode D2 and gate resistor Rgoff are connected in series between output node 14 and gate resistor 17. Diode D2 allows gate current Ig in the negative direction to flow through gate resistor Rgoff, and prevents gate current Ig in the positive direction from flowing through gate resistor Rgoff.

Switch 60 is connected in parallel with gate resistor Rgoff. By turning on switch 60, gate resistor Rgoff is short-circuited and its resistance value is set to 0. Turning on/off of switch 60 is controlled by freewheeling operation determination circuit 19.

Specifically, when it is determined that the diode of semiconductor element 1a is in the freewheeling operation, freewheeling operation determination circuit 19 turns on switch 60. When switch 60 is turned on, gate resistor Rga of semiconductor element 1a in the freewheeling operation is set to resistance value Rg0 of gate resistor 17.

On the other hand, when the diode of semiconductor element 1a is not in the freewheeling operation, or when it is determined that the freewheeling operation of the diode of semiconductor element 1a has been finished, freewheeling operation determination circuit 19 turns off switch 60. When switch 60 is turned off, gate resistor Rga of semiconductor element 1a is set to the sum of resistance value Rg0 of gate resistor 17 and a resistance value of gate resistor Rgon or gate resistor Rgoff.

That is, when semiconductor element 1a is turned on, switch 15a is turned on and on-bias voltage Vp is applied to the gate of semiconductor element 1a. Thereby, gate current Ig temporarily flows in the positive direction from power supply node 12, through switch 15a, output node 14, diode D1, gate resistor Rgon, and gate resistor 17. The resistance value of gate resistor Rga of semiconductor element 1a is set to Rg0+Rgon.

On the other hand, when semiconductor element 1a is turned off, switch 15b is turned on and off-bias voltage Vn is applied to the gate of semiconductor element 1a. Thereby, gate current Ig temporarily flows in the negative direction from the gate of semiconductor element 1a, through gate resistor 17, gate resistor Rgoff, diode D2, output node 14, and switch 15b. The resistance value of gate resistor Rga of semiconductor element 1a is set to Rg0+Rgoff.

As described above, while semiconductor element 1a is turned off and the diode of semiconductor element 1a performs the freewheeling operation, switch 60 is temporarily turned on. Thereby, gate resistor Rgoff is bypassed, and thus the resistance value of gate resistor Rga decreases from Rg0+Rgoff to Rg0.

While steep change dv/dt in drain voltage Vds occurs due to a recovery operation of the diode of semiconductor element 1a, a displacement current (Cgd×dv/dt) flows through gate-drain capacitance Cgd of semiconductor element 1. Since this displacement current flows through gate resistor Rga, gate voltage Vga increases. An increase amount ΔVga of gate voltage Vga can be expressed by the product of the displacement current and the resistance value of gate resistor Rga (ΔVgs=(Cgd×dv/dt)×Rga). In the fourth embodiment, increase amount ΔVga can be reduced by temporarily decreasing the resistance value of gate resistor Rga while the displacement current flows. Thereby, an increase in gate voltage Vga can be suppressed, and thus self turning-on of semiconductor element 1a can be prevented.

It should be noted that, when gate charge amount Qg decreases from Qa to 0 by the recovery operation of the diode of semiconductor element 1a, freewheeling operation determination circuit 19 determines that the freewheeling operation of the diode of semiconductor element 1a has been finished, and turns off switch 60. Thereby, the resistance value of gate resistor Rga is switched from Rg0 to Rg0+Rgoff.

Here, when gate resistor Rga has a small resistance value, an increase in gate voltage Vga can be suppressed and the self turning-on of semiconductor element 1a can be prevented, but vibration due to a floating inductance component of a gate wiring is generated, which may cause gate misfire. Further, electromagnetic noise is likely to have an influence, which may similarly trigger gate misfire. In gate drive circuit 10a according to the fourth embodiment, since the resistance value of gate resistor Rga is temporarily decreased to Rg0 only at timing at which the diode of semiconductor element 1a performs the recovery operation, and the resistance value of gate resistor Rga is set to Rgoff+Rg at timing other than that timing, it is possible to dump vibration of the gate while preventing the self turning-on of semiconductor element 1a. As a result, it is possible to prevent misfire of semiconductor element 1a.

### Operation of Gate Drive Circuit According to the Fourth Embodiment

Next, an operation of gate drive circuit 10a according to the fourth embodiment will be described.

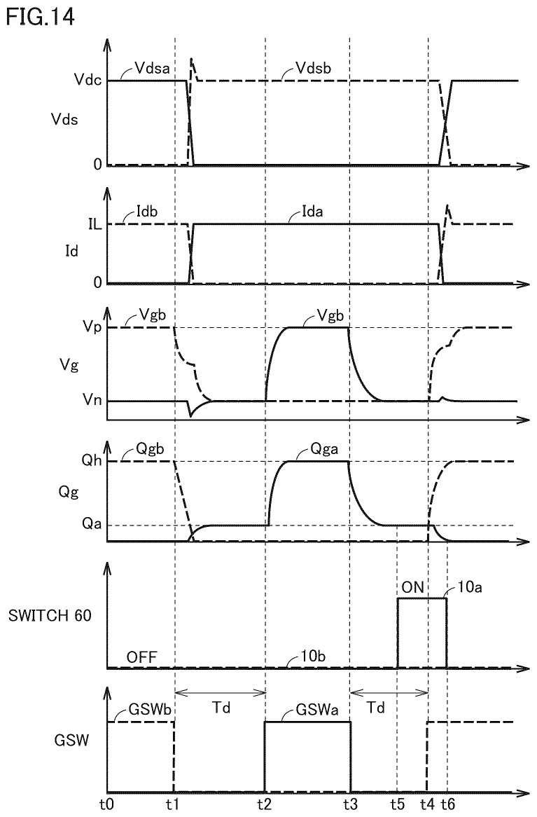

FIG. 14 is a time chart showing operations of semiconductor elements 1a and 1b. FIG. 14 shows waveforms of drain voltage Vds, drain current Id, gate voltage Vg, gate charge amount Qg, switch 60 of gate resistor switching circuit 20, and gate command signal GSW of semiconductor elements 1a and 1b. In each waveform, a solid line indicates a waveform of P-side semiconductor element 1a, and a broken line indicates a waveform of N-side semiconductor element 1b.

The time chart shown in FIG. 14 is different from the time chart shown in FIG. 5 in the waveform of gate voltage Vga of semiconductor element 1a. Since the other waveforms are the same as those shown in FIG. 5, detailed description thereof will be omitted.

As shown in FIG. 14, at time t0, gate command signal GSWa is at the L level, and gate command signal GSWb is at the H level. In gate drive circuit 10a, control circuit 11 turns off switch 15a and turns on switch 15b in response to gate command signal GSWa at the L level. Gate voltage Vga of semiconductor element 1a is set to off-bias voltage Vn, and semiconductor element 1a is set to the OFF state. Accordingly, drain current Ida is set as Ida=0, and drain voltage Vdsa is set as Vdsa=VDC. Since gate parasitic capacitances Cgd and Cgs of semiconductor element 1b are discharged, gate charge amount Qga is set to 0.

Freewheeling operation determination circuit 19 compares gate charge amount Qga with threshold value Qb. Since Qga<Qb, freewheeling operation determination circuit 19 determines that the diode of semiconductor element 1a is not in the freewheeling operation, and turns off switch 60 of gate resistor switching circuit 20. Therefore, the resistance value of gate resistor Rga of semiconductor element 1a is set to Rg0+Rgoff.

When gate command signal GSWb transitions from the H level to the L level at time t1, semiconductor element 1b is turned off. In gate drive circuit 10b, control circuit 11 turns off switch 15a and turns on switch 15b in response to gate command signal GSWb at the L level, and thereby applies off-bias voltage Vn to the gate of semiconductor element 1b. Since gate voltage Vgb of semiconductor element 1b is set to off-bias voltage Vn, gate charge amount Qgb of semiconductor element 1b gradually decreases from Qh. In response to completion of discharging of gate parasitic capacitances Cgs and Cgd, gate charge amount Qgb is set to 0.

Freewheeling operation determination circuit 19 compares gate charge amount Qgb with threshold value Qb. Since Qgb<Qb, freewheeling operation determination circuit 19 determines that the diode of semiconductor element 1b is not in the freewheeling operation, and maintains switch 60 of gate resistor switching circuit 20 in the OFF state. Therefore, a resistance value of a gate resistor Rgb of semiconductor element 1b is set to Rg0+Rgoff.

In response to turning-off of semiconductor element 1b, a freewheeling current flows through the diode of semiconductor element 1a. In a transient period in which drain voltage Vdsa steeply changes in response to the freewheeling current starting to flow through the diode, a displacement current (Cgd×dv/dt) flows through gate-drain capacitance Cgd of semiconductor element 1a. Since this displacement current flows through gate resistor 17 and gate resistor Rga of gate resistor switching circuit 20, gate voltage Vga decreases. Further, since gate parasitic capacitances Cgd and Cgs are charged by the displacement current, gate charge amount Qga increases from 0 to Qa.

The period from time t1 to time t2 corresponds to dead time Td. In dead time Td, the freewheeling current continues to flow through the diode of semiconductor element 1a.

When gate command signal GSWa transitions from the L level to the H level at time t2, semiconductor element 1a is turned on. Specifically, gate drive circuit 10a turns on switch 15a and turns off switch 15b in response to gate command signal GSWa at the H level, and thereby switches a voltage to be applied to the gate of semiconductor element 1a from off-bias voltage Vn to off-bias voltage Vp. Gate current Iga flows from power supply node 12 to the gate of semiconductor element 1a via gate resistor Rgon of gate resistor switching circuit 20 and gate resistor 17. Since gate parasitic capacitances Cgs and Cgd are charged, gate charge amount Qga gradually increases from Qa and reaches Qh. The freewheeling current flows between the drain and the source of semiconductor element 1a, and semiconductor element 1a performs the freewheeling operation.

When gate command signal GSWa transitions from the H level to the L level at time t3, semiconductor element 1a is turned off. In gate drive circuit 10a, control circuit 11 turns off switch 15a and turns on switch 15b in response to gate command signal GSWa at the L level, and thereby applies off-bias voltage Vn to the gate of semiconductor element 1a.

Since gate voltage Vga of semiconductor element 1a is set to off-bias voltage Vn, gate charge amount Qgb gradually decreases from Qh. Gate voltage Vga gradually decreases from on-bias voltage Vp toward off-bias voltage Vn. When gate voltage Vga becomes less than gate threshold voltage Vth, semiconductor element 1a starts to be turned off. When semiconductor element 1a is turned off, the freewheeling current starts to flow through the diode of semiconductor element 1a. Accordingly, drain voltage Vdsa and drain current Ida are maintained at constant values without being changed by turning-off of semiconductor element 1a.

Since the diode of semiconductor element 1a performs the freewheeling operation in dead time Td from time t3 to time t4, gate charge amount Qga does not decrease to 0 and is maintained at Qa. Freewheeling operation determination circuit 19 compares gate charge amount Qga in dead time Td immediately after the turning-off of semiconductor element 1a, with threshold value Qb. Since Qga (=Qa)>Qb, freewheeling operation determination circuit 19 determines that the diode of semiconductor element 1a is in the freewheeling operation. In response to determination that the diode of semiconductor element 1a is in the freewheeling operation, freewheeling operation determination circuit 19 turns on switch 60 at a time t5 after the turning-off of semiconductor element 1a. Thereby, the resistance value of gate resistor Rga of semiconductor element 1a is switched from Rgoff+Rg0 to Rg0.

It should be noted that timing of switching gate resistor Rga from Rgoff+Rg0 to Rg0 is preferably timing after gate current Iga finishes flowing in accordance with the turning-off of semiconductor element 1a (at time t3). This timing can be obtained based on gate parasitic capacitances Cgd and Cgs of semiconductor element 1a and the time constant of gate resistor 17. Alternatively, the timing of switching gate voltage Vga can be obtained based on fall time Tf of semiconductor element 1a or the like described in the data sheet or the like.

When gate command signal GSWb transitions from the L level to the H level at time t4, semiconductor element 1b is turned on. Specifically, gate drive circuit 10b turns on switch 15a and turns off switch 15b in response to gate command signal GSWb at the H level, and thereby switches a voltage to be applied to the gate of semiconductor element 1b from off-bias voltage Vn to on-bias voltage Vp.

When drain current Idb starts to flow through semiconductor element 1b in response to turning-on of semiconductor element 1b, drain voltage Vdsa of semiconductor element 1a steeply changes through a recovery operation of the diode of semiconductor element 1a. While change dv/dt in drain voltage Vdsa with respect to time occurs, a displacement current (Cgd×dv/dt) flows through gate-drain capacitance Cgd of semiconductor element 1a. Since this displacement current flows through gate resistor 17 and switch 60, gate charge amount Qga decreases from Qa to 0.

However, since the resistance value of gate resistor Rga of semiconductor element 1a decreases from Rgoff+Rg0 to Rg0 in dead time Td from time t3 to time t4, increase amount ΔVga of gate voltage Vga is suppressed and gate voltage Vga does not exceed gate threshold voltage Vth even if the displacement current flows through gate resistor 17 and gate resistor switching circuit 20 after time t4. Accordingly, it is possible to prevent the self turning-on of semiconductor element 1a. Therefore, it is possible to avoid an excessive short-circuit current from flowing through semiconductor elements 1a and 1b and destroying semiconductor elements 1a and 1b.

In gate drive circuit 10a, freewheeling operation determination circuit 19 compares gate charge amount Qga with threshold value Qb. Since Qga<Qb, freewheeling operation determination circuit 19 determines that semiconductor element la has finished the freewheeling operation. In response to determination that semiconductor element 1a has finished the freewheeling operation, freewheeling operation determination circuit 19 turns off switch 60 at a time t6. Thereby, the resistance value of gate resistor Rga of semiconductor element 1a is switched from Rg0 to Rgoff+Rg0.

That is, gate drive circuit 10a temporarily decreases the resistance value of gate resistor Rga of semiconductor element 1a from Rgoff+Rg0 to Rg0 in accordance with timing at which the diode of semiconductor element 1a performs the recovery operation. This can suppress gate voltage Vga from instantaneously increasing in response to the recovery operation and exceeding gate threshold voltage Vth.

Further, since gate drive circuit 10a sets the resistance value of gate resistor Rga to Rgoff+Rg at timing other than the timing at which the diode of semiconductor element 1a performs the recovery operation, it is possible to dump vibration of the gate of semiconductor element 1a, and as a result, it is possible to prevent misfire of semiconductor element 1a.

Operation waveforms when semiconductor element 1b performs the SW operation and semiconductor element 1a performs the freewheeling operation in the case of phase current IL<0 have been described above. In the case of phase current IL>0, semiconductor element 1a performs the SW operation and semiconductor element 1b performs the freewheeling operation, and operation waveforms thereof can be considered to be similar to those in FIG. 14.

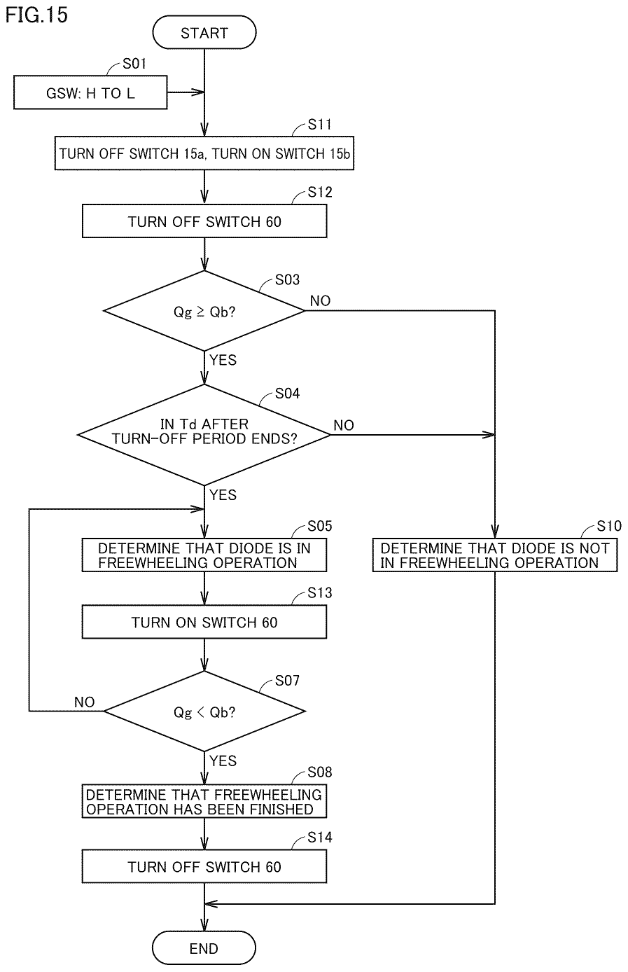

FIG. 15 is a flowchart showing an operation of gate drive circuit 10 according to the fourth embodiment. FIG. 15 shows the operation of gate drive circuit 10 when corresponding semiconductor element 1 is turned off in accordance with gate command signal GSW at the L level (an OFF command) from control device 130. Since determination of whether or not semiconductor element 1 performs the freewheeling operation when gate command signal GSW at the H level (an ON command) is received does not affect switching of a gate resistor Rg, the description thereof will be omitted.

The flowchart shown in FIG. 15 is different from the flowchart shown in FIG. 9 in that steps S02, S06, and S09 are replaced by steps S11 to S14.

As shown in FIG. 15, when semiconductor element 1 is in the ON state, on-bias voltage Vp is applied to the gate of semiconductor element 1. When gate command signal GSW at the L level (an OFF command) is received from control device 130 (step S01) in this state, control circuit 11 of gate drive circuit 10 turns off switch 15a and turns off switch 15b (step S11). Thereby, off-bias voltage Vn is applied to the gate of semiconductor element 1. Gate resistor switching circuit 20 maintains switch 60 in the OFF state (step S13). Therefore, a resistance value of gate resistor Rg of semiconductor element 1 is set to Rgoff+Rg.

Since gate voltage Vg of semiconductor element 1 is set to off-bias voltage Vn, gate charge amount Qg gradually decreases from Qh. When gate voltage Vga gradually decreases toward off-bias voltage Vn and becomes less than gate threshold voltage Vth, semiconductor element 1 starts to be turned off. Freewheeling operation determination circuit 19 compares gate charge amount Qg detected by gate charge amount detection circuit 18 with threshold value Qb (step S03). When gate charge amount Qg is less than threshold value Qb (when it is determined as NO in S03), freewheeling operation determination circuit 19 determines that the diode of semiconductor element 1 is not in the freewheeling operation (step S10).

On the other hand, when gate charge amount Qg is more than or equal to threshold value Qb (when it is determined as YES in S03), freewheeling operation determination circuit 19 subsequently determines whether or not current timing is in dead time Td after a turn-off period of semiconductor element 1 (step S04). The turn-off period can be obtained based on gate parasitic capacitances Cgd and Cgs of semiconductor element 1 and the time constant of gate resistor 17. Alternatively, the turn-off period can be obtained based on fall time Tf of semiconductor element 1a or the like described in the data sheet or the like.

When the current timing is in the turn-off period of semiconductor element 1, it is determined as NO in S04. In this case, freewheeling operation determination circuit 19 determines that the diode of semiconductor element 1 is not in the freewheeling operation (step S10).

On the other hand, when the current timing is in dead time Td after the turn-off period of semiconductor element 1 (when it is determined as YES in S04), freewheeling operation determination circuit 19 determines that the diode of semiconductor element 1 is in the freewheeling operation (step S05). In this case, gate resistor switching circuit 20 turns on switch 60 (step S13). Thereby, the resistance value of gate resistor Rg of semiconductor element 1 is switched from Rgoff+Rg to Rg.

When another semiconductor element 1 connected in series to semiconductor element 1 is turned on in dead time Td, the diode of semiconductor element 1 performs a recovery operation, and thus drain voltage Vds of semiconductor element 1 steeply changes. While change dv/dt in drain voltage Vds with respect to time occurs, a displacement current (Cgd×dv/dt) flows through gate-drain capacitance Cgd of semiconductor element 1. Accordingly, gate voltage Vg increases, and gate charge amount Qg decreases from Qa to 0.

Freewheeling operation determination circuit 19 compares gate charge amount Qb detected by gate charge amount detection circuit 18 with threshold value Qb (step S07). When gate charge amount Qg is more than or equal to threshold value Qb (when it is determined as NO in S07), freewheeling operation determination circuit 19 determines that semiconductor element 1 is in the freewheeling operation (step S05). Therefore, gate resistor switching circuit 20 continues to turn on switch 60 (step S13) to maintain the resistance value of gate resistor Rg of semiconductor element 1 at Rg.

On the other hand, when gate charge amount Qg is less than threshold value Qb (when it is determined as YES in S07), freewheeling operation determination circuit 19 determines that semiconductor element 1 has finished the freewheeling operation (step S08). In response to determination that semiconductor element 1 has finished the freewheeling operation, gate resistor switching circuit 20 turns off switch 60 (step S14). Thereby, the resistance value of gate resistor Rg of semiconductor element 1 is switched from Rg to Rgoff+Rg.

It should be noted that, although threshold value Qb is used for both the process of determining whether or not semiconductor element 1 is in the freewheeling operation (step S03) and the process of determining whether or not semiconductor element 1 has finished the freewheeling operation (step S07) also in the flowchart in FIG. 15, as in the flowchart in FIG. 9, different threshold values may be used for these two processes in accordance with characteristics of semiconductor element 1.

### Effects in the Fourth Embodiment

As described above, gate drive circuit 10 according to the fourth embodiment is configured to determine whether or not the diode of corresponding semiconductor element 1 performs the freewheeling operation based on the detection value of gate charge amount Qg of semiconductor element 1. Therefore, whether or not the diode of the semiconductor element performs the freewheeling operation can be simply determined, with no need to install a sense terminal for detecting a flow direction of a current in each semiconductor element 1.

Further, when it is determined that the diode of semiconductor element 1 performs the freewheeling operation, gate drive circuit 10 can temporarily decrease the resistance value of the gate resistor of semiconductor element 1, based on the detection value of gate charge amount Qg, in accordance with timing at which the diode of semiconductor element 1 performs the recovery operation in response to turning-on of other semiconductor element 1 connected in series to semiconductor element 1. Thus, the resistance value of the gate resistor can be decreased without excess or deficiency with respect to a time required to turn on other semiconductor element 1, and thereby it is possible to suppress an increase in gate voltage Vg of semiconductor element 1 and prevent occurrence of self turning-on. Further, a signal or the like for sensing timing of the turning-on of other semiconductor element 1 is not required. Therefore, gate resistor switching circuit 20, which is a circuit for suppressing self turning-on of semiconductor element 1, can be activated at appropriate timing, with a simple configuration. As a result, it is possible to suppress vibration of the gate while preventing the self turning-on of semiconductor element 1.

It should be understood that the embodiments disclosed herein are illustrative and non-restrictive in every respect. The scope of the present disclosure is defined by the scope of the claims, rather than the description above, and is intended to include any modifications within the scope and meaning equivalent to the scope of the claims.

### REFERENCE SIGNS LIST

1, 1a to 1f: power semiconductor element; 10, 10a to 10f: gate drive circuit; 11, 21: control circuit; 12: power supply node; 12U, 12V, 12W: leg; 13: reference node; 14: output node; 15, 15a, 15b, 16l, 16h, 25a, 25b, 60: switch; 16: off-bias switching circuit; 17, 26, Rgon, Rgoff: gate resistor; 18: gate charge amount detection circuit; 19: freewheeling operation determination circuit; 20: gate resistor switching circuit; 30: differential amplifier; 32: gate charge amount calculator; 40, 50: NOT circuit; 42: delay circuit; 44: one-shot circuit; 46: comparator; 48, 52: AND circuit; 100: power conversion device; 110: DC power supply; 120: motor; 130: control device; D1, D2: diode; PL: DC positive bus; NL: DC negative bus; Vp: on-bias power supply (on-bias voltage); Vn, Vnh, Vnl: off-bias power supply (off-bias voltage); T1: input terminal;

T2, T3: output terminal.

1. A drive circuit to drive a power semiconductor element, the power semiconductor element having a first main electrode on a high potential side, a second main electrode on a low potential side, a gate serving as a control electrode, and a diode connected in anti-parallel between the first main electrode and the second main electrode, the drive circuit comprising:
a control circuit to selectively apply an on-bias voltage and an off-bias voltage to the gate of the power semiconductor element in accordance with a control signal inputted from outside;
a detection circuit to detect a gate charge amount of the power semiconductor element; and
a determination circuit to determine whether or not the diode of the power semiconductor element performs a freewheeling operation based on the gate charge amount detected by the detection circuit.

2. The drive circuit for the power semiconductor element according to claim 1, further comprising an off-bias switching circuit to switch the off-bias voltage to be applied to the gate, between a first voltage and a second voltage lower than the first voltage, wherein
when the power semiconductor element is turned off in accordance with the control signal, the control circuit applies the off-bias voltage having the first voltage to the gate,
when the gate charge amount after turning-off of the power semiconductor element is greater than a first threshold value, the determination circuit determines that the diode of the power semiconductor element performs the freewheeling operation, and
in response to determination that the diode of the power semiconductor element performs the freewheeling operation, the off-bias switching circuit switches the off-bias voltage from the first voltage to the second voltage.

3. The drive circuit for the power semiconductor element according to claim 2, wherein
when the gate charge amount after the turning-off of the power semiconductor element is greater than the first threshold value, and the gate charge amount decreases to less than a second threshold value, the determination circuit determines that the freewheeling operation has been finished, and
in response to determination that the freewheeling operation has been finished, the off-bias switching circuit switches the off-bias voltage from the second voltage to the first voltage.

4. The drive circuit for the power semiconductor element according to claim 2, wherein
when the gate charge amount after the turning-off of the power semiconductor element is smaller than the first threshold value, the determination circuit determines that the power semiconductor element does not perform the freewheeling operation, and
in response to determination that the power semiconductor element does not perform the freewheeling operation, the off-bias switching circuit maintains the off-bias voltage at the first voltage.

5. The drive circuit for the power semiconductor element according to claim 2, wherein the first voltage is 0 V.

6. The drive circuit for the power semiconductor element according to claim 1, further comprising a gate resistor switching circuit to switch a gate resistor of the power semiconductor element, between a first resistance value and a second resistance value smaller than the first resistance value, wherein
when the power semiconductor element is turned off in accordance with the control signal, the control circuit applies the off-bias voltage to the gate via the gate resistor having the first resistance value,
when the gate charge amount after turning-off of the power semiconductor element is greater than a first threshold value, the determination circuit determines that the diode of the power semiconductor element performs the freewheeling operation, and
in response to determination that the diode of the power semiconductor element performs the freewheeling operation, the gate resistor switching circuit switches the gate resistor from the first resistance value to the second resistance value.

7. The drive circuit for the power semiconductor element according to claim 6, wherein
when the gate charge amount after the turning-off of the power semiconductor element is greater than the first threshold value, and the gate charge amount decreases to less than a second threshold value, the determination circuit determines that the freewheeling operation has been finished, and
in response to determination that the freewheeling operation has been finished, the gate resistor switching circuit switches the gate resistor from the second resistance value to the first resistance value.

8. The drive circuit for the power semiconductor element according to claim 6, wherein
when the gate charge amount after the turning-off of the power semiconductor element is smaller than the first threshold value, the determination circuit determines that the power semiconductor element does not perform the freewheeling operation, and
in response to determination that the power semiconductor element does not perform the freewheeling operation, the gate resistor switching circuit maintains the gate resistor at the first resistance value.

9. A power conversion device comprising:
a DC positive bus and a DC negative bus;
first and second power semiconductor elements connected in series between the DC positive bus and the DC negative bus; and
the drive circuit according to claim 1 to drive each of the first and second power semiconductor elements.
